(19) United States
(12) Patent Application Publication
(10) Pub. No.: US 2025/0279867 A1
(43) Pub. Date: Sep. 4, 2025

(54) RESOURCE ALLOCATION SIGNALNG IN A WIRELESS LOCAL AREA NETWORK PREAMBLE

(71) Applicant: HUAWEI TECHNOLOGIES CO., LTD., Shenzhen (CN)

(72) Inventors: Oded REDLICH, Hod Hasharon (IL); Genadiy TSODIK, Hod Hasharon (IL); Shimon SHILO, Hod Hasharon (IL); Mengshi HU, Shenzhen (CN); Jian YU, Shenzhen (CN)

(21) Appl. No.: 19/211,617

(22) Filed: May 19, 2025

Related U.S. Application Data
(63) Continuation of application No. 17/860,735, filed on Jul. 8, 2022, now Pat. No. 12,341,721.
Application No. 17/860,735 is a continuation of application No. PCT/EP2020/050607, filed on Jan. 10, 2020.

(51) Int. Cl. H04L 5/00; H04W 72/23; H04W 84/12

(52) U.S. Cl. CPC H04L 5/0053; H04W 72/23; H04W 84/12

(57) ABSTRACT

An apparatus for wireless communication, comprising: a memory that stores instructions; and a processor coupled with the memory, wherein the processor and the memory are configured to: generate a signaling field, SIG, in a wireless local area network, WLAN, the SIG comprises a resource unit, RU, allocation field, indicating a size and location of each RU in a frequency resource, the SIG further comprises one or more user field, each user field comprises information of a scheduled station, STA; wherein a MRU which comprises multiple RUs is allowed to be assigned to one STA; and transmit the SIG.

### CROSS-REFERENCE TO RELATED APPLICATIONS

This application is a continuation of U.S. patent application Ser. No. 17/860,735, filed on Jul. 8, 2022, which is a continuation of International Application No. PCT/EP2020/050607, filed on Jan. 10, 2020. All of the afore-mentioned patent applications are hereby incorporated by reference in their entireties.

### FIELD OF THE INVENTION

The present invention relates to a wireless communication, and more particularly, to a new method of resource allocation signaling in a WLAN and apparatus.

### BACKGROUND OF THE INVENTION

In the IEEE 802.11ax standard, OFDMA modulation was first introduced. The description of which RUs are used for a given PPDU is given in its SIG-B field (and defined in details in the 802.11ax standard, illustrated in FIG. 1). This field is comprised of 2 main sub-field: the common field and the user specific field as depicted in the 802.11ax standard.

The 802.11ax standard limits each non-AP STA to use a single resource unit (RU) that is comprised of contiguous tones (sub-carriers). Although there are various RU sizes defined in the standard (e.g. 26, 52, 106, 242, 484, 996 tones), restricting the allocation to a single RU limits the usage of the channel resource.

As mentioned above, in the current 802.11ax standard (i.e. the prior art) there are 6 sizes of RUs. In the allocation process, the scheduler can allocate only a single RU to a given STA in a MU-PPDU (Multi-User Phy Protocol Data Unit—the transmitted packet) or SU-PPDU (Single-User PPDU) transmission.

If there is an unallocated RU, it cannot be assigned to a STA that has already been given a RU.

### SUMMARY OF THE INVENTION

The present invention is contemplated to expand and improve the method of utilizing the channel resources in WLAN.

Methods, apparatuses, and computer readable media for resource allocation signaling in an extremely high throughput wireless local area network (WLAN) are disclosed.

Apparatus such as an access point (AP) may generate a signaling field, SIG. The SIG comprises a resource unit (RU) allocation field, indicating a size and location of each RU in a frequency resource. The SIG further comprises one or more user fields, each user field comprises information of a scheduled station, STA; wherein a MRU which comprises multiple RUs (MRU) is allowed to be assigned to one or more STAs (same). The RU comprises a RU defined in 802.11ax. The MRU may be a small MRU which comprises combination of 26-RU, 52-RU, or 106-RU in a 20 MHz frequency segment; or a large MRU which comprises combination of 242-RU, 484-RU, or 996-RU in the transmission bandwidth.

In some examples, the MRU comprises a first RU and a second RU. The apparatus may generate a first user field corresponding to the first RU and a second user field corresponding to the second RU. Both, the first user field and the second user field, comprise the same ID of the STA. The second user field may further include one or any combination of the following: the number of RUs assigned to the STA; or the size and location of each RU in the MRU assigned to the STA.

Alternatively, the apparatus may generate a common field of the SIG comprising information for small MRU allocated in a corresponding 20 MHz frequency segment; and/or information for a number of the large MRU allocated in the bandwidth of the transmission.

Alternatively, the apparatus may generate a Single-RU user field and a MRU user field. The Single-RU user field corresponds to a RU, which is not a MRU. The MRU user field corresponds to a MRU, comprising at least the following: a STA_ID, a RU bitmap indicating size and location of each RU comprised in the MRU.

Alternatively, the apparatus may generate a Common-MRU field indicating which 26-RUs are comprised in a MRU in a corresponding 20 MHz frequency segment; and/or a Common-MRU field indicating which 242-RUs are comprised in a MRU in a bandwidth of the transmission.

Alternatively, the apparatus may generate one or more common-MRU fields, each common-MRU field indicating whether an actual allocated RU is in a MRU is in a MRU (which actual allocated RUs are in a MRU).

Further, other information such as channel puncturing information in an U-SIG may be for indicating the MRU allocation. The puncturing information indicates a non-contiguous large RU and one or more user fields corresponding to the non-contiguous large RU, wherein each of the one or more user fields comprises a different station's information.

One or more stations (e.g., wireless or mobile devices) may receive the WLAN preamble, including the SIG. The one or more stations may then determine a MRU which comprises multiple RUs assigned to the STA based on the SIG. The stations may then determine a MRU assigned to the STA by:
a first user field corresponding to the first RU and a second user field corresponding to the second RU; both of the first user field and the second user field comprising a same ID of the STA; the second user field may further include one or any combination of the following: the number of RUs assigned to the STA; or, the size and location of each RU in the MRU assigned to the STA; or
a common field of the SIG comprising information for small MRU allocated in a corresponding 20 MHz frequency segment; and/or information for a number of the large MRU allocated in the bandwidth of the transmission, or
a Single-RU user field and a MRU user field; the Single-RU user field corresponds to a RU which is not a MRU; the MRU user field corresponds to a MRU, comprising at least the following: a STA_ID and a RU bitmap indicating size and location of each RU comprised in the MRU; or
a Common-MRU field indicating which 26-RUs are comprised in a MRU in a corresponding 20 MHz frequency segment; and/or a Common-MRU field indicating which 242-RUs are comprised in a MRU in a bandwidth of the transmission; or
one or more common-MRU fields, each common-MRU field indicating whether an actual allocated RU is in a MRU (which actual allocated RUs are in a MRU); or
other information such as puncturing information indicating a non-contiguous large RU and one or more user fields corresponding to the non-contiguous large RU, each of the one or more user fields comprises a different station's information.

The above mentioned fields in the SIG may be load-balanced in two or more channel content. The mapping between the MRU (RU if exists) and the STA are indicated by the structure of the fields and the location of the fields in the SIG.

Methods executed by the apparatus, including the AP and the stations are also provided, computer readable media for resource allocation signaling are also provided.

Some examples of the methods, apparatuses, or non-transitory computer-readable media described herein may further include processes, features, means, or instructions for resource allocation signaling in a extremely high throughput WLAN preamble. Further scope of the applicability of the described systems, methods, apparatuses, or computer-read able media will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram illustrating SIG-B field (and defined in details in the 802.11ax standard;

FIG. 2 is a diagram showing the example of a wireless local area network;

FIG. 3 is a flowchart illustrating how communicating scheduling information in WLAN on a transmitting side;

FIG. 4 is a flowchart illustrating how communicating scheduling information in WLAN on a receiving side;

FIG. 5 is a diagram illustrating an example of indication structure of the embodiment 1;

FIG. 6 is a diagram illustrating another example of resource allocation in an embodiment;

FIG. 7 is a diagram illustrating another example of indication structure in an embodiment;

FIG. 8 is a diagram illustrating another example of indication structure in an embodiment;

FIG. 9a, 9b, 9c are diagrams illustrating examples of the common field of the EHT-SIG;

FIG. 10a is a diagram illustrating an example of resource allocation and the station scheduled on the RU(s);

FIG. 10b is a diagram illustrating an example of a structure of a common field of the EHT-SIG which indicates the resource allocation of FIG. 10a;

FIG. 11a is a diagram illustrating an example of structure of the user specific field of the EHT-SIG in an embodiment;

FIG. 11b is a diagram illustrating an example of structure to the MRU user field in the user specific field of an EHT-SIG;

FIG. 12a and FIG. 12b are diagrams illustrating a structure of the user fields in a user specific field of an EHT-SIG;

FIG. 13 is a diagram illustrating simulation results;

FIG. 14 is a diagram illustrating another example of indication structure of a Common-MRU;

FIG. 15 is a diagram illustrating an example of resource allocation and UR mapping in an embodiment;

FIG. 16 is a diagram illustrating an example of resource allocation and UR mapping in an embodiment;

FIG. 17a is a diagram illustrating another example of resource allocation in an embodiment;

FIG. 17b is a diagram illustrating an indication structure of the resource allocation in the FIG. 17a;

FIG. 17c is a diagram illustrating another indication structure of the resource allocation in the FIG. 17a;

FIG. 18 is a diagram illustrating another example of resource allocation and its indication structure;

FIG. 19 is a diagram illustrating an example of a transmission contains a mixed type of MRU;

FIG. 20 is a diagram illustrating another example of resource allocation in an embodiment;

FIG. 21 is a block diagram of an access point according to an embodiment of the present invention; and

FIG. 22 is a block diagram of a station according to an embodiment of the present invention.

### DETAILED DESCRIPTION OF THE INVENTION

Hereinafter, a method of utilizing the channel resources in 802.11be by allowing STAs to use multiple and non-contiguous portions of the channel according to an embodiment of the present invention will be explained with reference to the accompanying drawings.

For ease of understanding, terms that possibly appear in the following embodiments are explained as follows:
AP access point
AT access terminal
BSS basic service set
BW bandwidth
CC content channel
DL downlink
DS distribution system
EHT extremely high throughput
ESS extended service set
HE high efficiency
LLC logical link control
L-LTF Non-HT Long Training field
L-SIG Non-HT SIGNAL field
L-STF Non-HT Short Training field
LTF long training field
MAC medium access protocol
MCS modulation and coding scheme
MLD multi-link device
MRU multiple resource units
MS mobile station
MU multi-user
MU-MIMO multi-user multiple input, multiple output
NDP null data PPDU
OFDM orthogonal frequency division multiplexing
OFDMA orthogonal frequency division multiple access
PHY physical layer
PPDU PHY protocol data unit
RA RU allocation field
RL-SIG Repeated Non-HT SIGNAL field
RU resource unit
SAP service access point
SS subscriber station
STA station
SU single user
TDLS tunneled direct link setup
TID traffic identifier
TXOP transmission opportunity
UE user equipment
UL Uplink
U-SIG Universal SIGNAL field
WM wireless medium

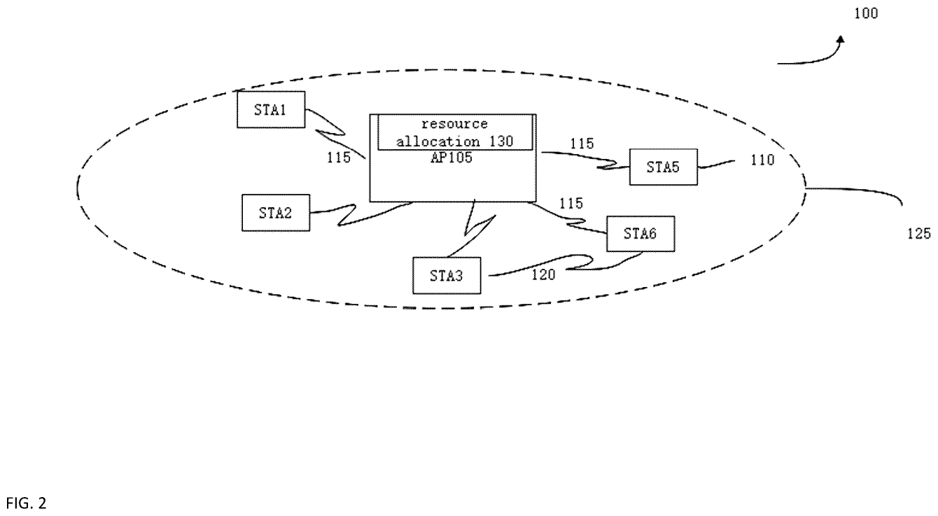

FIG. 2 illustrates an example of a wireless local area network (WLAN) 100 that supports resource allocation signaling or scheduling signaling in an WLAN preamble (e.g., a EHT WLAN preamble) in accordance with various aspects of the present disclosure.

The WLAN 100 includes an access point (AP) 105 and stations (STAs) 110 labeled as STA 1 through STA 6. The STAs 110 may represent devices such as wireless communication terminals, including mobile stations, phones, personal digital assistant (PDAs), other handheld devices, netbooks, notebook computers, tablet computers, laptops, display devices (e.g., TVs, computer monitors, etc.), printers, etc. While only one AP 105 is illustrated, the WLAN 100 can have multiple APs 105. STAs 110, can also be referred to as a mobile station (MS), mobile device, access terminals (ATs), user equipment (UE), subscriber station (SS), or subscriber units. The STAs 110 associate and communicate with the AP 105 via a communication link 115. Each AP 105 has a coverage area 125 such that STAs 110 within that area are within range of the AP 105. The STAS 110 are dispersed throughout the coverage area 125. Each STA 110 is stationary, mobile, or a combination thereof. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands. One or more of the STAs 110 and/or APs 105 may comprise a resource allocation signaling component 130, which may enable the STAs 110 and/or the APs 105 to signal resource allocations in a WLAN preamble, for example as further discussed below with reference to FIGS.

Although not shown in FIG. 2, a STA 110 can be covered by more than one AP 105 and can therefore associate with multiple APs 105 at different times. A single AP 105 and an associated set of STAs 110 is referred to as a basic service set (BSS). An extended service set (ESS) is a set of connected BSSs. A distribution system (DS) is used to connect APs 105 in an extended service set. A coverage area 125 for an AP 105 can be divided into sectors making up only a portion of the coverage area. The WLAN 100 includes APs 105 of different types (e.g., metropolitan area, home network, etc.), with varying sizes of coverage areas and overlapping coverage areas for different technologies. Although not shown, other devices can communicate with the AP 105.

While the STAs 110 are capable of communicating with each other through the AP 105 using communication links 115, STAs 110 can also communicate directly with each other via direct wireless communication links 120. Direct wireless communication links can occur between STAS 110 regardless of whether any of the STAs is connected to an AP 105. Examples of direct wireless communication links 120 include Wi-Fi Direct connections, connections established by using a Wi-Fi Tunneled Direct Link Setup (TDLS) link, and other peer-to-peer (P2P) group connections.

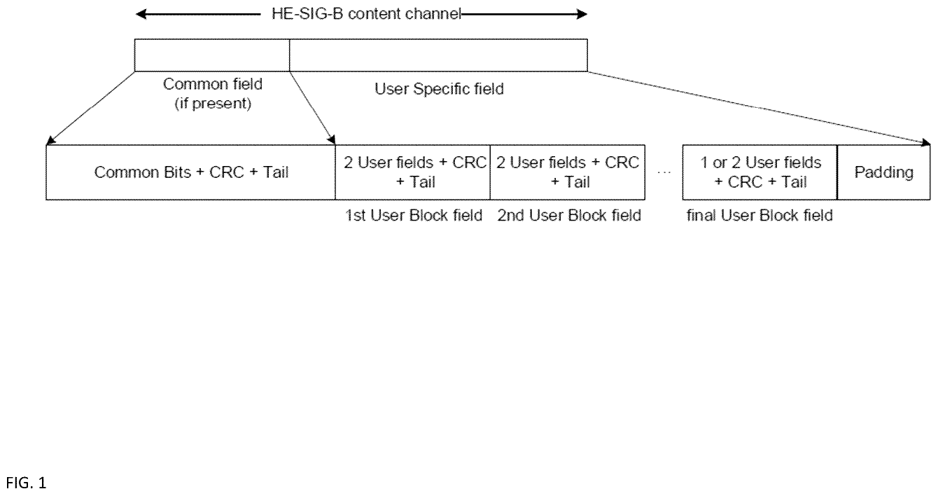

The STAs 110 and APs 105 shown in FIG. 1 communicate according to the WLAN radio and baseband protocol including physical (PHY) and medium access control (MAC) layers from IEEE 802.11, and its various versions including, but not limited to, 802.11b, 802.11g, 802.11a, 802.11n, 802.11ac, 802.11ad, 802.11ah, 802.11Z, 802.11ax, etc.

Transmissions to/from STAs 110 and APs 105 oftentimes include UL (uplink) or DL (downlink) transmission. In downlink transmission, control information within a header that is transmitted prior to data transmissions. The information provided in a header is used by a device to decoded the subsequent data. Extremely high throughput WLAN preambles can be used to schedule multiple devices, such as STAs 110, for single-user simultaneous transmission (e.g., single-user orthogonal frequency division multiple access (SU OFDMA)) and/or MU-MIMO transmissions. In one example, an EHT WLAN signaling field may be used to signal a resource allocation pattern to multiple receiving STAs 110. The EHT WLAN signaling field includes a common field that is decodable by multiple STAs 110, the common field including a resource allocation field. The resource allocation field indicates resource unit distributions to the multiple STAs 110 and indicates which resource units in a resource unit distribution correspond to MU-MIMO transmissions and which resource units correspond to OFDMA single-user transmissions. The EHT WLAN signaling field also includes, subsequent to the common field, dedicated user fields that are assigned to a certain STA 110. The order in which the dedicated user fields are generated corresponds to the allocated resource units (e.g., the first dedicated user field corresponds to the first allocated resource unit). The EHT WLAN signaling field is transmitted with a WLAN preamble to the multiple STAs 110.

It is not limited that some of the embodiments can be used in uplink transmission, that is, some of the features or solutions are used in an trigger which triggers an uplink transmission.

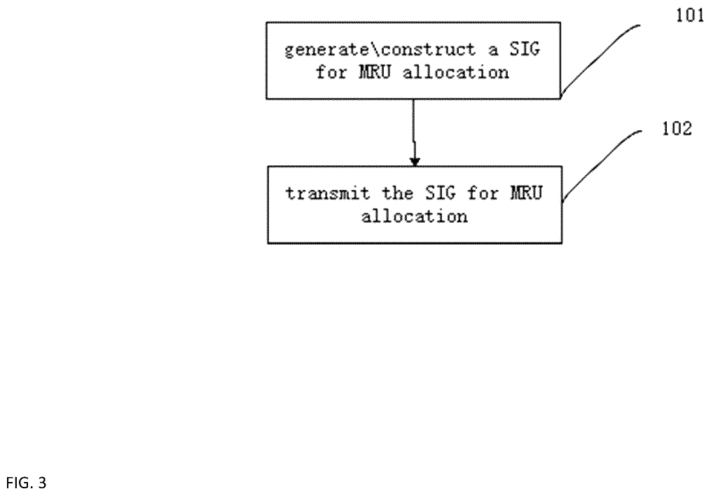

An embodiment comprising a method of communicating scheduling information in WLAN, as illustrated in FIG. 3:

101. Generating an SIG (such as a EHT-SIG) comprising indication information or scheduling information, by an apparatus such as an access point. The generate may be replaced by construct, obtain or determine.

102. Transmit the SIG, by the apparatus.

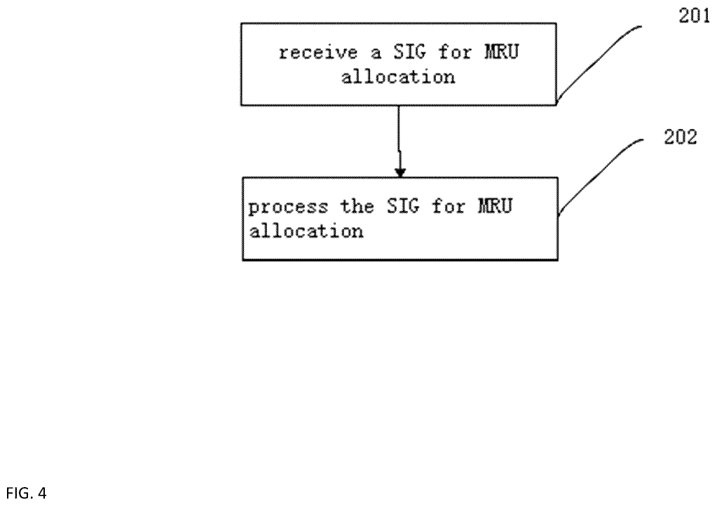

Accordingly, another embodiment comprising an method on a non-AP station, receiving scheduling information in WLAN, as illustrated in FIG. 4.

201. Receiving an PPDU, in which an SIG (such as EHT-SIG) is included. The SIG may be in the structure discussed in the following embodiments. A PPDU may include L-STF, L-LTF, L-SIG, RL-SIG, a U-SIG and a EHT-SIG.

There may be a 2 OFDM symbol long, jointly encoded U-SIG in the EHT preamble immediately after the RL-SIG. The U-SIG contains version independent fields. The intent of the version independent content is to achieve better coexistence among future 802.11 generations. In addition, the U-SIG can have some version dependent fields. The U-SIG is sent using 52 data tones and 4 pilot tones per 20 MHz. There may be a variable modulation and coding scheme (MCS) and variable length EHT-SIG, immediately after the U-SIG, in an EHT PPDU sent to multiple users.

202. Process the SIG. Specifically, obtaining scheduling information based on the SIG.

The EHT-SIG is a field's name to differentiate from other SIG-Bs, such as VHT-SIG-B, HE-SIG-B. The EHT-SIG may be renamed in other ways; that is, the name itself does not matter, but the content and structures discussed and described in the following embodiments provides the solution of efficiently scheduling the resources and stations.

First, in the embodiments, by the EHT-SIG, a resource unit (RU) allocation field indicates at least a sequence of RUs (size and location of each RU) in a frequency domain, and may also indicate information needed to compute the number of users allocated to each RU. The EHT-SIG further comprises one or more user field, each user field comprises information of a scheduled station, STA; wherein multiple contiguous or non-contiguous RUs defined in 802.11ax (may be called MRU, or MRU) are allowed to be assigned to one or more STA. “MRU” used in this document usually points to the RU which is a combination of the multiple contiguous or non-contiguous RUs defined e.g. in 802.11ax. They can be taken as a RU(s) newly defined in the next generation of 802.11ax, for example, 802.11be.

Compared with 802.11ax, each RU Allocation subfield in an EHT-SIG content channel corresponding to a 20 MHz frequency segment indicates the RU assignment, including the size of the RU(s) and their placement in the frequency domain, and one or more combinations of multiple RUs, to be used in the EHT modulated fields of the EHT MU PPDU in the frequency domain, and may also indicate information needed to compute the number of users allocated to each RU (non-MRU) and each combination of multiple RUs (MRU). In preferred embodiments, the subcarrier indices of the RU(s) meet the conditions in a Table which may be defined in a 802.11be standard (RUs associated with each RU Allocation subfield for each EHT SIG content channel and PPDU bandwidth).

One or multiple STAs may be allocated to the same MRU or 802.11ax RU (non-MRU) in a MU-MIMO format. This means that part of the RA subfield content will define the number of STAs, similarly to 802.11ax definitions: 11000y2y1y0, 11001y2y1y0 and 11010y2y1y0 for 242-RU, 484-RU and 996-RU respectively. However, in 802.11be, the maximum of 16 STAs per RU may be supported, therefore the embodiments may include a RU allocation field (RA) with a value of more than 8 bits, for example, 9 bits or 10 bits to support the indication of the number of the stations.

For example: 11000y3y2y1y0, indicating a 242-RU, on which the number of stations on the 242-RU is indicated by y3y2y1y0, which equals y3y2y1y0+1;

11001y2y1y0 indicating a 484-RU, on which the number of stations on the 484-RU is indicated by y3y2y1y0, which equals y3y2y1y0+1;

11010 y3 y2y1y0, indicating a 996-RU, on which the number of stations on the 996-RU is indicated by y3y2y1y0, which equals y3y2y1y0+1.

The embodiments in the following have omitted the difference (if exists) of the RA between the 802.11ax to make the solutions of the embodiment or examples concise. That is, value(s) of the RA(s) used in the following embodiment/examples can be replaced by a new value which are corresponding to 802.11be. In some embodiments, the number of RUs that can be combined as a MRU is limited. That is to say, limit MRUs may be defined, each MRU represents a size of a multiple subcarriers and the location of the multiple subcarriers in the bandwidth, which overlaps multiple 802.11ax defined RU.

Based the defined RUs in 802.11ax, for example small RU: 26, 52, or 106, some examples of MRU (combinations) includes: a MRU comprising {52, 26}, or {106, 26} within a 20 MHz, a 40 MHz or a 80 MHz band. In some examples, only the combinations of contiguous small-size RUs should be introduced, in some examples, non-contiguous configuration is also allowed. For large RUs: 242, 484, or 996, some reasonable preferred MRU (combinations) include:
1. 242+484 (contiguous and non-contiguous, within each 80 MHz segment);
2. 242+242 (Punctured case, non-contiguous);
3. 484+996;
4. 242+484+242+484;
5. 242+484+996;
6. 242+242+996, etc.

Further, based on some predefined MRU (i.e. defined combination of RUs of 802.11ax, may also called MRU), an important issue is to provide an efficient indication solution to indicate the allocation of the MRU and the corresponding information of the station scheduled on the MRU. With other words, the problem is how to indicate the allocation and station information which allows multiple RUs allocated to one station, and accordingly how the station obtains whether the station is scheduled and on which RU or MRU the station is allocated, so as that the station communicates on the allocated RU or MRU accordingly.

Still further, the RUs assignment is decided by the AP according to various criteria. For example the AP may decide to use the RUs with the highest SNR for a specific user and these RUs are not necessarily contiguous. Further, all RUs in a transmission may contain the same data packet for a station, and all RUs in the MRU and together with other RUs in the PPDU are for the same service type.

Specifically, in some of the embodiments, a single FEC with the same parameters (such as MCS, coding, N_SS etc.) may be assigned to a STA allocated with MRU.

Small RUs and large RUs mentioned above might not be assigned to the same MRU allocation, or it is not preferred to assign a MRU, which includes both small RUs and large RUs. Small RUs may not be assigned across multiple 20 MHz channels in preferred embodiments. In simple words, the MRU comprises a combination of 26-RU, 52-RU, or 106-RU in a 20 MHz frequency segment; or the MRU comprises combination of 242-RU, 484-RU, or 996-RU in a transmission bandwidth. But the MRU might not comprise one of 26-RU, 52-RU, and 106-RU in a first 20 MHz and one of 242-RU, 484-RU, or 996-RU which overlaps another 20 MHz.

Some embodiments may have some exception that a special small RU in a first 20 MHz channel can be combined with a RU in another 20 MHz channel.

In some embodiments, it is not limited that the MRUs of small RUs to be comprised only of contiguous RUs. This can support the schedulers to allocate RUs based on SNR (e.g. CQI feedback), it would be efficient to allow any combination of MRU.

This is not limited to the combinations of small RUs.

Assuming the RMS delay spread is ˜⅓ CP=˜1 μsec, then the coherence BW is ˜1 MHz. Therefore, an average SNR on a given RU does not imply about the average SNR on its adjacent RU.

In the embodiments, based on supporting multiple RUs/non-contiguous RUs, the channel utilization is improved by making it more efficient due to enhancing the capability of leveraging the channel selectivity. Further, the usage of the channel is improved, and will increase the overall system throughput and performance.

### Embodiment 1

An EHT-SIG in this embodiment is different from the HE-SIG B specified in 802.11ax, in the following:

It is allowed that a corresponding multiple user-field points to the same STA. A common part is included in the EHT-SIG, and is similar to the structure of the common part of the HE-SIG B. However, multiple user-fields of one STA are included in a User Specific field of the EHT-SIG. For example, a first user field is followed by other duplicated second user-fields. In simple words, a MRU comprises a first RU and a second RU. The EHT-SIG accordingly comprises a first user field corresponding to the first RU and a second user field corresponding to the second RU. Both of the first user field and the second user field comprising the same ID of a station.

The first user field can be similar to the user field as defined in 802.11ax, but there are different solutions for the other duplicated user-fields, record as a duplicated second user-field(s), or the second user-field.

Specifically, in one example, the duplicated second user-field is the same as the first user-field. This example overcomes the prejudice of only one user field/station mapped to one RU as set forth in 802.11ax, so being cost-efficient when designing a new chip.

In another example, the duplicated second user-fields include the STA_ID field and other subfields which carry new signaling content related to MRU instead. Compared to the first example, this solution supports MRU STAs in an easier way.

In the above mentioned examples, the user-fields' size may the same between each other, e.g. 21, 22 or 23 bits. The first user-field might be identical/similar to the 802.11ax user-field (the content or structure are mainly the same).

Generally, the location of the combined second RU (corresponding to duplicated user field) is not limited; but in some examples, rules of the location of the combined second RU/duplicated user-field is set to reduce interferences or inefficiency.

The other user-fields' content may be one of the following:

Example 1, remains the same of the first user-field;

Example 2, includes content which is different with the first user-field such that:

The first 11 bits are for STA_ID as in the first user-field.

Some of the other bits (e.g. 1 or 2) are used to signal type of the user-field (i.e. the meaning of the following bits).

The remaining bits may have any combination of the new following content related to MRU:

2 bits indicate N_RU—the number of RUs assigned to the STA (including the first RU), or how many RUs are included in the MRU assigned to the STA. Thus, the STA may be capable to identify a failure to decode any of the user-fields and stop the decoding process. Other 8 bits are reserved; or

the size and location of each RU in the MRU assigned to the STA are indicated. For example, in the following way:

For small-RUs: a 9-bit bitmap may indicate which 26-tones RUs in the same 20 MHz channel are part of the MRU allocation. A 52-tones RU may be indicated by the appropriate 2 bits; a 106 tones RU may be indicated by the appropriate 4 bits. The 10th bit is reserved.

For large-RUs: a 8-bits bitmap may indicate which 242-tones RUs in the same 80 MHz channel and the next 80 MHz channel are part of the MRU allocation. A 484-tones RU may be indicated by 2 bits (2×242 tones-RU); a 996-tones RU may be indicated by 4 bits (4×242 tones-RU). The 9th and 10th bits are reserved. MRU is limited to 160 MHz boundaries in this embodiment. A STA may know if a MRU is assigned to it after it finished decoding EHT-SIG. Thus no need for special signaling for MRU user-field is required.

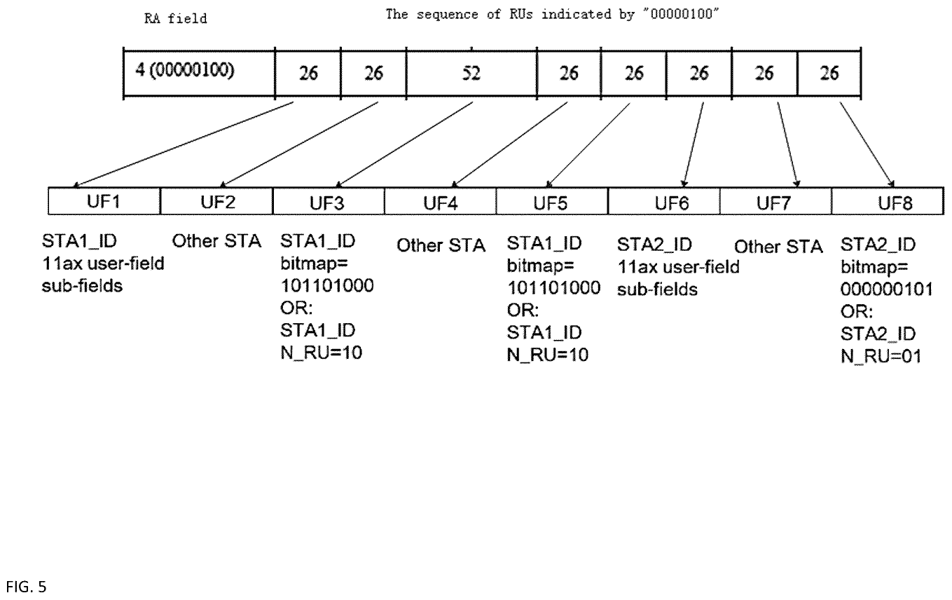

FIG. 5 illustrates an example of indication structure of the embodiment 1. A RU allocation (RA) field in the common part of EHT-SIG is set as “00000100”, which represents the allocation of a sequence of RUs [26, 26, 52, center-26, 26, 26, 26, 26]. Accordingly, in a corresponding user specific field, 8 user fields (UF) are included. In this example, the UF1 is mapped with the first 26-RU, including information of STA1, such as AID of STA1. The UF2 is mapped with the second 26-RU, includes information of another STA, the content and structure might also similar to a user field in 802.11ax.

The UF3 corresponds to the 52-RU, the UF3 comprises a station info field which is also set as the AID of STA1. The content of the UF3 includes different examples:

In one example, the UF3 further includes a bitmap “101101000”, each bit of the bitmap correspond to a 26-RU respectfully, indicating which 26-RUs are in the MRU assigned/allocated to the STA1. In the example, the “101101000” means the first/third/fourth/6th 26-RU are comprised as a MRU, which is allocated to the STA1.

In another example, the UF3 alternatively further includes a N-RU field instead of the bitmap. The N-RU field indicates the number of the RUs in the sequence of RUs of [26, 26, 52, center-26, 26, 26, 26, 26] that are combined as a MRU, which is allocated to the STA1. In this example, the number of the RUs is 3.

Other UFs are also described in the FIG. 5.

On the station side, a STA may obtain the size and location of the sequence of RUs allocated corresponding to a 20 MHz from the RA field, and may also obtain whether the STA is scheduled/assigned and on which of one or more RUs the STA is allocated.

For example, the STAs may obtain the sequence of RUs allocated corresponding to a 20 MHz is a sequence of RUs [26, 26, 52, center-26, 26, 26, 26, 26], based on the “00000100”, and further obtain that the STA is scheduled and scheduled on the first, third and 5th RU in the above sequence of RUs (the first, third and 5th is the order in the sequence) based on the UF1, UF3, UF5. That is, the MRU comprised by “first 26-RU, second 52-RU, the 6th 26-RU”, “first 26-RU, second 52-RU, the 6th 26-RU” is the order in the 20 MHz tone plan.

TABLE 27-7
Data and pilot subcarrier indices for RUs in a 20
MHz HE PPDU and in a non-OFDMA 20 MHz HE PPDU

| RU type | RU index and subcarrier range | | | | |
|---|---|---|---|---|---|
| 26-tone RU | RU 1 | RU 2 | RU 3 | RU 4 | RU 5 |
| | [−121: −96] | [−95: −70] | [−68: −43] | [−42: −17] | [−16: −4, 4: 16] |
| | RU 6 | RU 7 | RU 8 | RU 9 | |
| | [17: 42] | [43: 68] | [70: 95] | [96: 121] | |
| 52-tone RU | RU 1 | RU 2 | RU 3 | RU 4 | |
| | [−121: −70] | [−68: −17] | [17: 68] | [70: 121] | |

| | | |
|---|---|---|
| 106-tone RU | RU 1 | RU 2 |
| | [−122: −17] | [17: 122] |

| | |
|---|---|
| 242-tone RU | RU 1 |
| | [−122: −2, 2: 122] |

The subcarrier index of 0 corresponds to the DC tone. Negative subcarrier indices correspond to subcarries with frequecy lower than the DC tone, and positive subcarrier indices correspond to subcarriers with frequency higher than the DC tone.
RU 5 is the middle 26-tone RU.

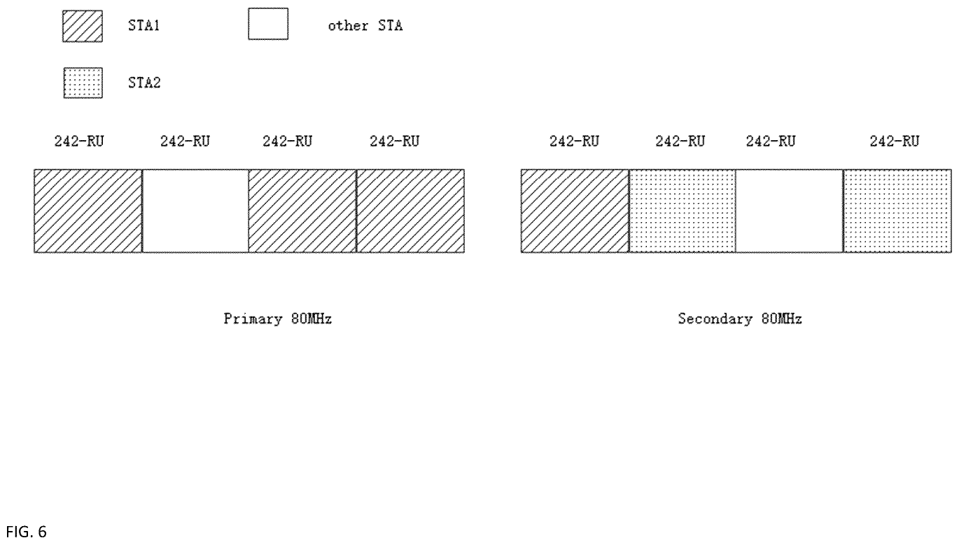

As shown in FIG. 6, illustrates another example of resource allocation in the embodiment 1, in the 160 MHz, the first, third, 4th, 5th 242-RU are assigned to STA1; the 6th, 8th 242-RU are assigned to STA2.

There are different solutions of the content of the common part and the UFs in the EHT-SIG indicating the allocation in FIG. 6. The common part can be divided into two content channel (CC).

In the example, the common part of CC1 comprises “11000000(RA-1, 242(1)), 01110010(RA-3, 484(0)), 11000000(RA-5, 242(1)), 11000000(RA-7, 242(1))”; the common part of CC2 comprises “11000000(RA-2, 242(1)), 11001000(RA-4, 484(1)), 11000000(RA-6, 242(1)), 11000000(RA-8, 242(1))”. The “11000000(RA-1), 01110010(RA-3), 11000000(RA-5), 11000000(RA-7)” in CC1 correspond to the first 20 MHz, the third 20 MHz, the 5th 20 MHz and the 7th 20 MHz respectively; the “11000000(RA-2), 11001000(RA-4), 11000000(RA-6) and 11000000(RA-8)” in CC2 correspond to the second 20 MHz, the 4th 20 MHz, the 6th 20 MHz and the 8th 20 MHz. The “11000000” indicates an allocation of 242(1), i.e. 242-RU with 1 user field, “01110010” indicates an allocation of 484-RU with 0 user field in the content channel that contains the corresponding 8-bit RU Allocation subfield “01110010”. “11001000” indicates an allocation of 484-RU with 1 user field in the content channel that contains the corresponding 8-bit RU Allocation subfield “11001000”. The common part of the CC1 together with the common part of the CC2 indicates the allocation of the 160 MHz, i.e. the sequence of the RUs [242, 242, 484, 242, 242, 242, 242].

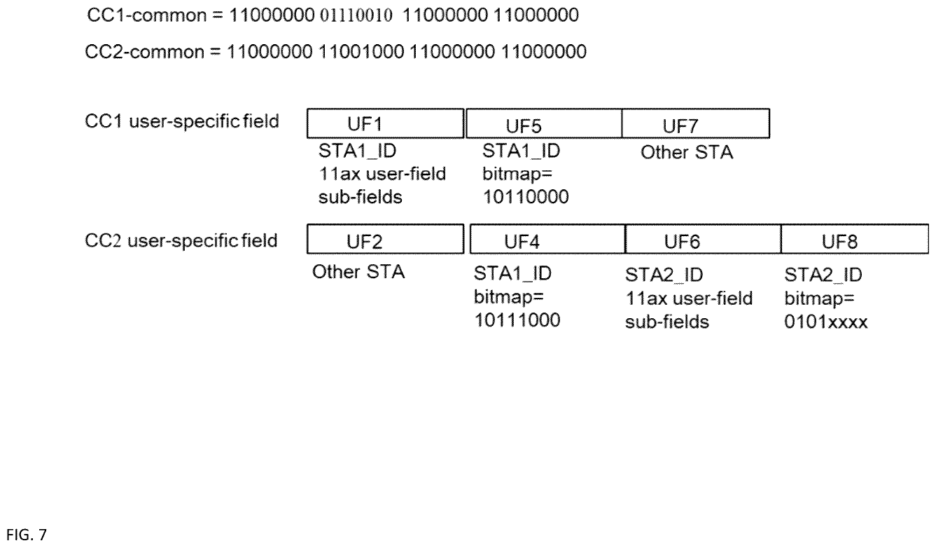

See FIG. 7, in the EHT-SIG, CC1 and CC2 are included. The CC1 comprises UF1, UF5 and UF7, corresponding to the RA1, RA5, RA7 respectively. The CC2 comprises UF2, UF4, UF6 and UF8, corresponding to the RA2, RA4, RA6, RA8 respectively.

UF1 is the first user field comprising the ID of STA1. UF4 and UF5 are second user field comprising the ID of STA1 (same to UF1) and a first bitmap, which is 8 bits, each bit of the 8 bits indicating whether a corresponding 242-RU is in the MRU assigned to the STA1 (for example the 10111000 indicates the he first, third, 4th, 5th 242-RU are assigned to STA1). UF6 and UF8 includes same ID of STA2, in UF8 it is preferred to include a second bitmap, which is 8 bits or remaining bits except the RUs already allocated in the first bitmap (i.e. 4 bits in this example), each bit of the 8 bits indicating whether a corresponding 242-RU is in the MRU assigned to the STA1 (for example the 10111000 indicate that the first, third, 4th and 5th 242-RU are assigned to STA1). UF2 and UF7 are user field which are not assigned with a MRU, details are not discussed here.

In this example, if RU r is a 484-tone or larger RU, which is the largest predefined RU in a MRU, then the number of users allocated to the MRU equals the number of User fields for this RU r in the MRU summed across both EHT-SIG-B content channels, i.e., Nuser(r, CC1)+Nuser(r, CC2), r is the largest RU in the MRU. In the above example, a 484-RU and a 242-RU are included a MRU assigned to STA1, the number of users is decided by the 484-RU: n1(the second 484-RU, CC1)+n2(the second 484-RU, CC2)=0+1=1. In this example, it assigns one station in the MRU, but it is not limit that multiple stations are assigned to the MRU.

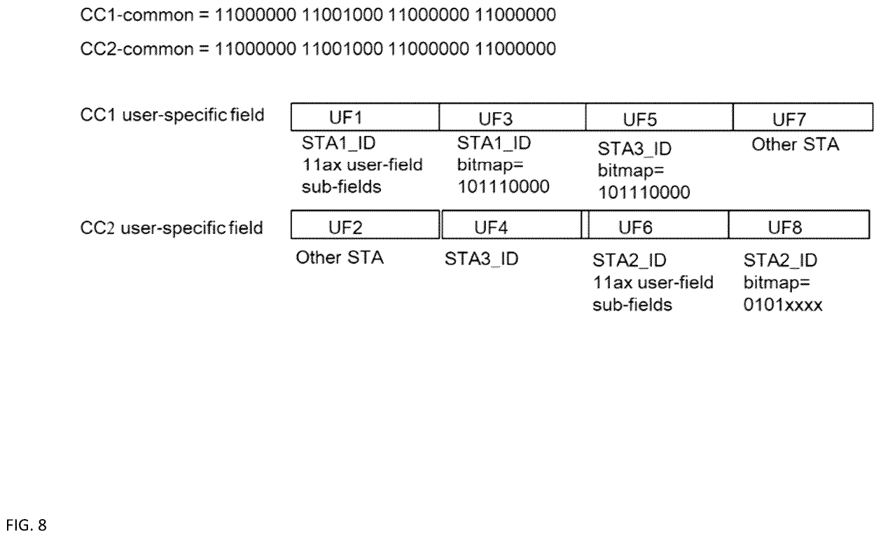

In the example of FIG. 8, the resource allocation is similar, but the MRU1 which including the 484-RU are allocated to two stations. In this example, common part of CC1 comprises “11000000(RA-1, 242(1)), 11001000(RA-3, 484(1)), 11000000(RA-5, 242(1)), 11000000(RA-7, 242(1))”; common part of CC2 comprises “11000000(RA-2, 242(1)), 11001000(RA-4, 484(1)), 11000000(RA-6, 242(1)), 11000000(RA-8, 242(1))”. The “11000000(RA-1), 11001000(RA-3), 11000000(RA-5), 11000000(RA-7)” in CC1 correspond to the first 20 MHz, the third 20 MHz, the 5th 20 MHz and the 7th 20 MHz respectively; the “11000000(RA-2), 11001000(RA-4), 11000000(RA-6), 11000000(RA-8)” in CC2 correspond to the second 20 MHz, the 4th 20 MHz, the 6th 20 MHz and the 8th 20 MHz. The “11000000” indicates an allocation of 242(1), i.e. 242-RU with 1 user field; “11001000” indicates an allocation of 484-RU with 1 user field in the content channel that contains the corresponding 8-bit RU Allocation subfield “11001000”. The common part of the CC1 together with the common part of the CC2 indicates the allocation of the 160 MHz, i.e. the sequence of the RUs [242, 242, 484, 242, 242, 242, 242].

UF1 corresponds to the first 242-RU in the MRU1, it is the first user field comprising the ID of STA1.

In the UF3, UF4 correspond to a same 484-RU in the MRU1 assigned to two stations (indicated by RA3 and RA4), for example STA1 and STA3, and should include the ID of STA1 and the ID of STA3 respectively. If the UF3 includes the ID of STA1, the UF3 is a second user field for STA1 (indicating the second 484-RU is in the MRU1), further including a first bitmap, which is 8 bits, each bit of the 8 bits indicating whether a corresponding 242-RU is in the MRU assigned to the STA1; the UF4 includes the ID of STA3, the UF3 is a first user field for STA3.

Alternatively, if the UF3 includes the ID of STA3, the UF3 is a first user field for STA3; the UF4 can include the ID of STA1, the UF3 is a second user field for STA1 (indicating the second 484-RU is in the MRU1), further including a first bitmap, which is 8 bits, each bit of the 8 bits indicating whether a corresponding 242-RU is in the MRU assigned to the STA1.

UF5 corresponds to the RA5 (indicating the 5th 242-RU), is a second user field comprising the ID of STA1 or STA3 (indicating the 5th 242-RU is in the MRU1) and a first bitmap, which is 8 bits, each bit of the 8 bits indicating whether a corresponding 242-RU is in the MRU assigned to the STA1 and STA3 (for example the 10111000 indicates the he first, third, 4th, 5th 242-RU are assigned to STA1 and STA3).

UF6 and UF8 includes same ID of STA2, in UF8 it is preferred to include a second bitmap, which is 8 bits or remaining bits except the RUs already allocated in the first bitmap (i.e. 4 bits in this example), each bit of the 8 bits indicating whether a corresponding 242-RU is in the MRU assigned to the STA1 (for example the 10111000 indicates the he first, third, 4th, 5th 242-RU are assigned to STA1).

UF2 and UF7 are user field which are not assigned with a MRU, details are not discussed here.

In this example, if RU r is a 484-tone or larger RU, which is the largest predefined RU in a MRU, then the number of users allocated to the MRU equals the number of User fields for this RU r in the MRU summed across both EHT-SIG-B content channels, i.e., Nuser(r, CC1)+Nuser(r, CC2), r is the largest RU in the MRU. In the above example, a 484-RU and a 242-RU are included a MRU assigned to STA1, the number of users is decided by the 484-RU: n1(the second 484-RU, CC1)+n2(the second 484-RU, CC2)=1+1=2. in this example, it assigns two stations in the MRU, but it is not limit that more than two stations are assigned to the MRU.

In the embodiment 1, by Modify remaining bits in duplicated user-fields, it is allowed to indicate additional MRU info; and this solution does not require additional entries in the RU Allocation subfield; and MRU definition and signaling is simple.

### Embodiment 2

In the second embodiment, the EHT-SIG includes a common field which accommodates additional RUs, and in which the RU allocation comprises combinations of RUs (MRU). In addition, a user-specific field that has a sub-field that defines MRU allocations, which is different from the 802.11ax user-specific field.

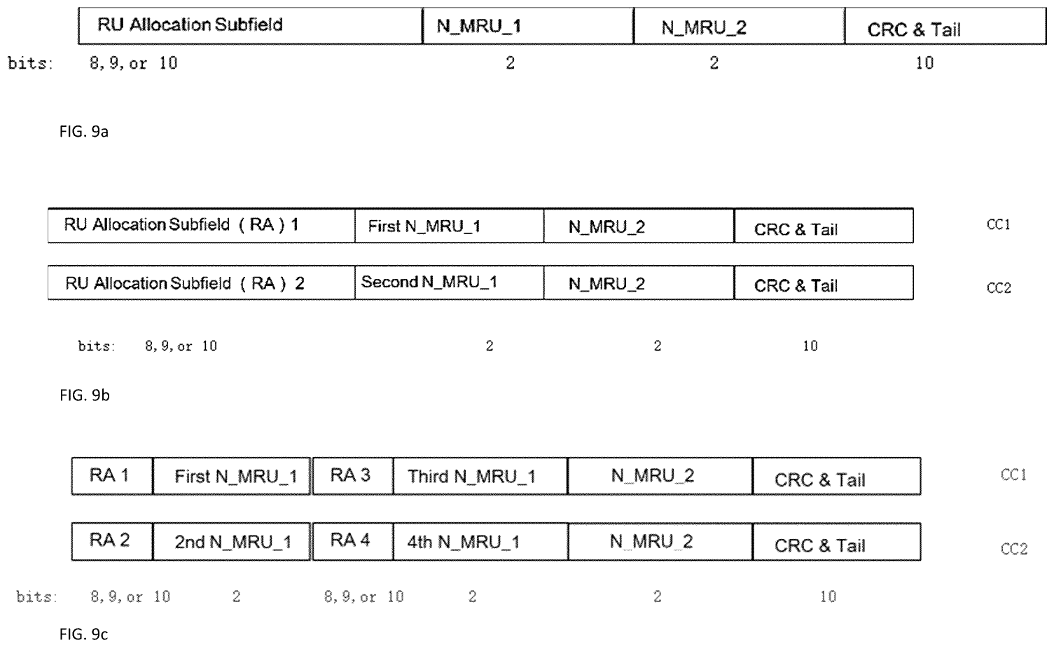

FIG. 9a, 9b, 9c illustrates an example of the common field of the EHT-SIG. In the common field of the EHT-SIG, one or more fields are included beside an RA field and other information (e.g., the RA field corresponding to a 20 MHz segment or a 40 MHz segment may be longer than in the prior art to allow more allocations or allow more STA assigned).

The one or more fields comprises a first field and/or a second field. The first field, N_MRU_1, corresponds to each 20 MHz segment exists in the overall BW, which occupies N×2 bits, the first field indicates a number of MRUs (a small MRU comprises a RU with a small size, such as a 26 RU, a 52 RU or a 106 RU) exists in each 20 MHz channel. The second field, N_MRU_2, corresponds to the entire bandwidth of the transmission, indicates a number of (how many) MRUs with a larger size (a large MRU comprises a RU such as a 242-RU, a 484-RU, or a 996 RU) in the bandwidth of the transmission. Specifically, the N_MRU_2 is the same for both CC1 & CC2 as it refers to the entire BW. N_MRU_1 refers to each 20 MHz separately, so it is most probably different between CC1 and CC2.

Details are as the following:

N_MRU_1 field (N×Nb bits)—which may also be called a number of small MRU field, this field indicates a number of (how many) small MRU allocated/exist in the corresponding 20 MHz channels/frequency segment. This field may be located following each of the RU allocation (RA) subfield respectively in each content channel (CC) of the EHT-SIG. The total overheads of the N_MRU_1 field in the EHT-SIG may be N×Nb bits, N is the number of 20 MHz channels in CC1 or CC2, Nb is 1 or 2. A small MRU is a RU combined by several small RU with size of any of 26, 52, or 106. It is not limit that the RUs in a small MRU includes different sizes of small RU, and it is also not limit that the small MRU may be larger than 106, but a small MRU is within a 20 MHz, otherwise a larger RU such as a 242-RU, 484-RU, 996 RU, or 2×996 RU may be indicated. It may be likely that only a single MRU is available per 20 MHz frequency segment. Hence this field may require either 1 bit or 2 bits, so if 1 bit is implemented then ‘1’ indicates that there exist a MRU in a corresponding 20 MHz frequency segment and ‘0’ indicates no MRUn a corresponding 20 MHz frequency segment. This may also be helpful later with embodiment 3.

N_MRU_2 field—which may also be called a number of large MRU field, this field indicates a number (how many) of large MRU allocation exist in the entire BW. This field may be located before the CRC & Tails of each CC, respectively in the EHT-SIG. The total overheads of the N_MRU_2 field in the EHT-SIG may be 2 bits, N is the number of 20 MHz frequency segments. A large MRU is a RU combined by several large RU with size of any of 242, 484, or 996. It is not limit that the RUs in a large MRU includes different sizes of large RU, and it is also not limit that the large MRU may be larger than 996, but a large MRU is within the full bandwidth of the transmission.

FIG. 9a illustrates a structure of a common part of EHT-SIG B in a 20 MHz bandwidth transmission.

FIG. 9b illustrates a structure of a common part of EHT-SIG B in a 40 MHz bandwidth transmission.

FIG. 9c illustrates a structure of common part of EHT-SIG B in an 80 MHz bandwidth transmission. Other structure of a common part of EHT-SIG B in other bandwidth are similar and will not be repeated herein.

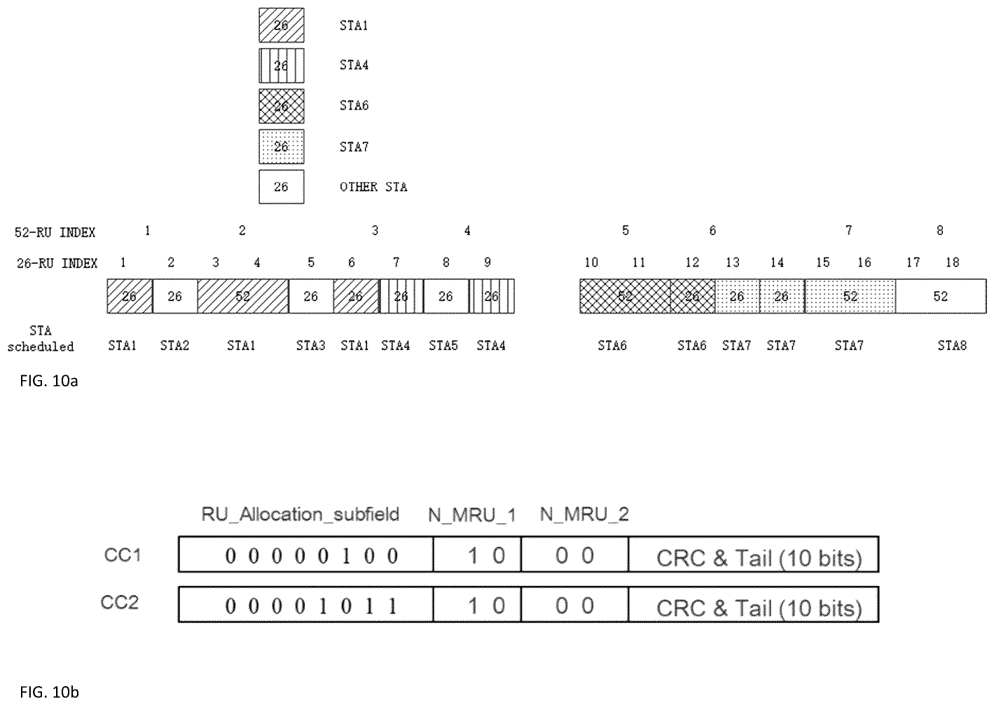

FIG. 10a describes an example of resource allocation and the station scheduled on the RU(S). FIG. 10b describes a structure of a common field of the EHT-SIG, which indicates the resource allocation of FIG. 10a. The common field comprises: a RU allocation subfield “00000100” which indicates the allocation which represents [26, 26, 52, center 26, 26, 26, 26]. The first field “10” indicates that there are 2 MRUs in the corresponding 20 MHz channel (the MRU for STA1 and the MRU for STA2 in FIG. 9a above). The second field “00” indicates that there are no MRUs of large RUs. The common field further comprises a RU allocation subfield “00001011” which indicates the allocation which represents [52, 26, 26, center 26, 52, 52]. The first field “10” indicates that there are 2 MRUs in the corresponding 20 MHz channel (the MRU for STA3 and STA4 in FIG. 9a). The second field “00” indicates that there are no MRUs of large RUs.

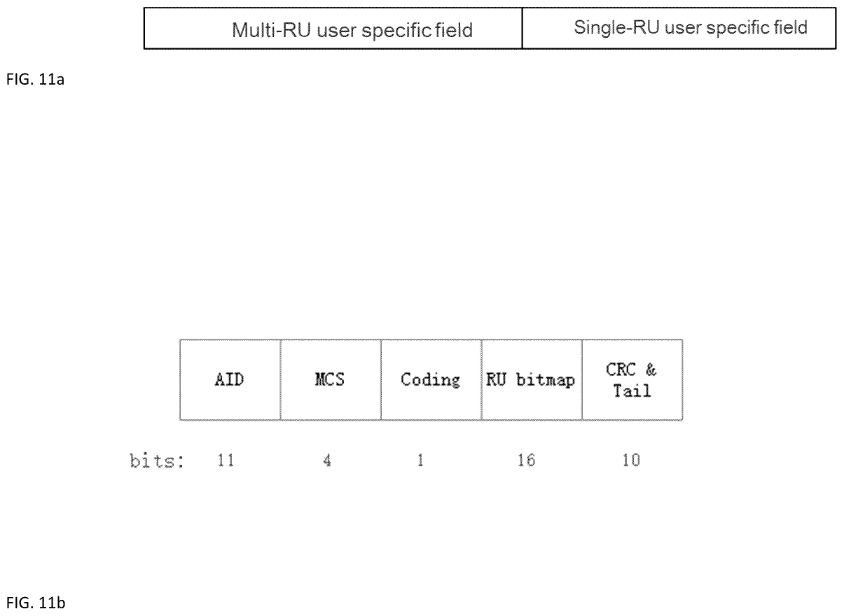

FIG. 11a describes an example of structure of the user specific field of the EHT-SIG in this embodiment. The user specific field includes 2 sub-fields:

a MRU user specific field, normally precedes a single-RU specific field,

the Single-RU user specific field. A Single-RU user specific field comprises one or more the Single-RU user field assigned on a Single-RU, which is a normal RU without combined with other RU(s). A MRU user field corresponding to a MRU, comprising at least the following: a STA_ID and a RU bitmap indicating size and location of each RU comprised in the MRU. FIG. 11b illustrated an example of structure to the MRU user field in the user specific field of the EHT-SIG.

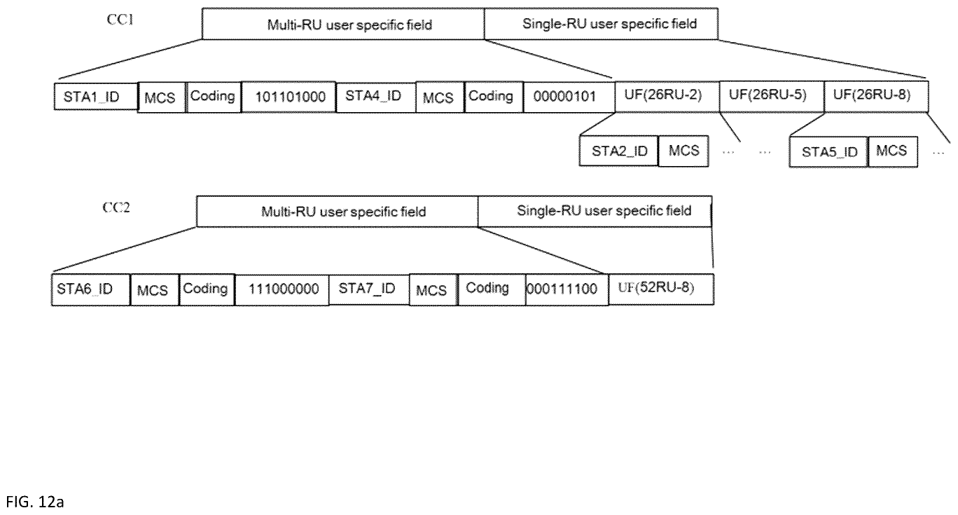

In the FIG. 12a and FIG. 12b, illustrates a structure of the user fields in a user specific field of the EHT-SIG, following the example of FIG. 10a. The MRU user field contains the following information:

a STA_ID (11 bits), MCS (4 bits), Coding (1 bit), a RU bitmap, which RU bitmap indicates RUs that belong to the same MRU allocation, CRC & Tail (10 bits).

Specifically, the RU bitmap indicating size and location of each RU comprised in the MRU can be indicated by at least two method. For one example, for small RUs there are 9 26-tones RUs, therefore the RU bitmap in each CC includes 9 bits, each bits maps a 26-RU, see FIG. 12a.

Alternatively, in another example, based on the RU allocation field indicates the sequence of the RUs (for example FIG. 10b), the number of RUs in each 20 MHz frequency segment may be extracted from the common field. The RU bitmap in each CC includes several bits. The number of bits equals to the number of the RUs in the allocation of the 20 MHz frequency segments. Each bits maps a RU in the sequence of the RUs respectively; see FIG. 12b. The RU bitmap in CC1 comprises 8 bits since the sequence of the RUs of the first 20 MHz frequency segment comprises 8 RUs. Each bit maps a RU in the 8 RUs. The RU bitmap in CC2 comprises 6 bits since the sequence of the RUs of the first 20 MHz frequency segment comprises 6 RUs, each bit maps a RU in the 6 RUs.

In another example, for large RUs there are 16 242-tones RUs in a 320 MHz bandwidth (BW); similarly, the RU bitmap in a user field of an EHT-SIG may comprises 16 bits, each bit maps a 242-tones RU, indicate whether the 242-tones RU is included in the MRU.

In the above embodiment 2, by separating MRU user-specific and Single-RU user specific fields, MRU information may be added, Same error probability of SIG-B per STA, For MRU that consists of 3 or more RUs total size is reduced.

### Embodiment 3

In some embodiments, new RU sizes are defined, which new size is called a MRU.

Accordingly, the RU-Allocation subfield comprises entries/indexes indicating the allocation including the MRU.

In this embodiment, the user-specific field will not be increased because only a single user-field is required for each RU or MRU. That is, it's not necessary that multiple user fields are included corresponding to an MRU.

As mentioned that the RUs assignment is decided by the AP according to various criterion. Needed resources of a station in a transmission is considered when determine the preferred RU or MRU.

The following table 1 is an example of the needed resources (especially smaller than a 20 MHz) and the preferred RU or MRU based on the needed resources.

TABLE 1

| Resources needed | |
|---|---|
| at most(number | |
| of subcarriers) | |
| by a station | RU/MRUs/full bandwidth |
| 1 × 26 | 26-RU |
| 2 × 26 | 26 + 26 MRU; 52-RU; |
| 3 × 26 | 26 + 26 + 26 MRU; 52 + 26 MRU |
| 4 × 26 | 26 + 26 + 26 + 26 MRU; 52 + 26 + 26 MRU; |
| | 52 + 52 MRU; 106-RU |
| 5 × 26 | 26 + 26 + 26 + 26 + 26 MRU; 26 + 26 + 26 + 52 |
| | MRU; 26 + 52 + 52 MRU; 106 + 26 MRU; etc . . . |
| 6 × 26 | 26 + 26 + 26 + 26 + 26 + 26 MRU; |
| | 26 + 26 + 26 + 26 + 52 MRU; 26 + 26 + 52 + 52 |
| | MRU; 106 + 26 + 26 MRU; 106 + 52 MRU, etc. |
| 7 × 26 | 26 + 26 + 26 + 26 + 26 + 26 + 26 MRU; |
| | 26 + 26 + 26 + 26 + 26 + 52 MRU; 26 + 26 + |
| | 26 + 52 + 52 MRU; 106 + 26 + 26 + 26 MRU; |
| | 106 + 52 + 26 MRU, etc. |
| 8 × 26 | 26 + 26 + 26 + 26 + 26 + 26 + 26 + 26 MRU; |
| | 26 + 26 + 26 + 26 + 26 + 26 + 52 MRU; |
| | 26 + 26 + 26 + 26 + 52 + 52 MRU; 106 + 26 + |
| | 26 + 26 + 26 MRU; 106 + 26 + 52 + 26 MRU; |
| | 106 + 106 MRU, etc. |
| 9 × 26 | 26 + 26 + 26 + 26 + 26 + 26 + 26 + 26 + |
| | 26 MRU; 26 + 26 + 26 + 26 + 26 + 26 + 26 + |
| | 52 MRU; 26 + 26 + 26 + 26 + 26 + 52 + 52 |
| | MRU; 106 + 26 + 26 + 26 + 26 + 26 |
| | MRU; 106 + 26 + 26 + 52 + 26 MRU; 106 + 26 + |
| | 106 MRU; |
| | 242-RU; full bandwidth in a 20 MHz |
| | PPDU, etc . . . |

The new table of RU Allocation subfield are based on one or more of the above RU/MRUs, and number of the MRU, locations of each RU in the MRU may also being considered. The more flexible the MRU is, the more indexes are needed. Preferred RU/MRUs may be defined and limited to reduce the complexity of the RU Allocation subfield.

The following table 2 is another example of the needed resources (especially larger than a 20 MHz, 320 MHz bandwidth is supported) and the preferred RU or MRU based on the needed resources.

TABLE 2

| Resources needed | |
|---|---|
| at most(number | |
| of subcarriers) | |
| by a station | RU/MRUs |
| 1 × 242 | 242-RU; full bandwidth in a 20 MHz |
| | PPDU |
| 2 × 242 | 242 + 242 MRU; 484-RU; full bandwidth in |
| | a 40 MHz PPDU |
| 3 × 242 | 242 + 242 + 242 MRU; 484 + 242 MRU |
| 4 × 242 | 242 + 242 + 242 + 242 MRU; 242 + 242 + |
| | 484 MRU; 484 + 484 MRU; 996-RU; full |
| | bandwidth in a 80 MHz PPDU |
| 5 × 242 | 242 + 242 + 242 + 242 + 242 MRU; |
| | 242 + 242 + 242 + 484 MRU; 242 + 484 + |
| | 484 MRU; 996 + 242 MRU, etc. |
| 6 × 242 | 242 + 242 + 242 + 242 + 242 + 242 MRU; |
| | 242 + 242 + 242 + 242 + 484 MRU; |
| | 242 + 242 + 484 + 484 MRU; 242 + 242 + |
| | 996 MRU, 996 + 484 MRU |
| 7 × 242 | 242 + 242 + 242 + 242 + 242 + 242 + |
| | 242 MRU; 242 + 242 + 242 + 242 + 242 + |
| | 484 MRU; 242 + 242 + 242 + 484 + 484 MRU; |
| | 242 + 242 + 242 + 996 MRU; 996 + 484 + |
| | 242 MRU |
| 8 × 242 | 242 + 242 + 242 + 242 + 242 + 242 + 242 + |
| | 242 MRU; 242 + 242 + 242 + 242 + 242 + 242 + |
| | 484 MRU; 242 + 242 + 242 + 242 + 484 + |
| | 484 MRU; 242 + 242 + 242 + 242 + 996 MRU; |
| | 996 + 484 + 242 + 242 MRU; 2 × 996-RU; full |
| | bandwidth in a 160 MHz |
| 9 × 242 | . . . 2 × 996 + 242 MRU |
| 10 × 242 | . . . 2 × 996 + 484 MRU |
| 11 × 242 | . . . 2 × 996 + 484 + 242 MRU |
| 12 × 242 | . . . 2 × 996 + 996 MRU |
| 13 × 242 | . . . 2 × 996 + 996 + 242 MRU |
| 14 × 242 | . . . 2 × 996 + 996 + 484 MRU |
| 15 × 242 | . . . 2 × 996 + 996 + 484 + 242 MRU |
| 16 × 242 | . . . full bandwidth in a 320 MHz PPDU |

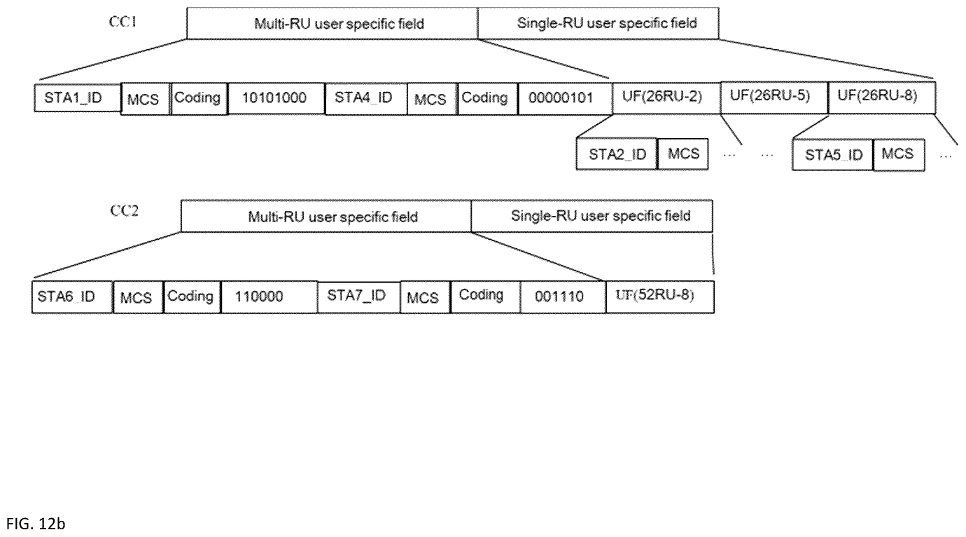

To reduce complexity of the indication and meet the resource needs more efficiently. preferred MRUs are provided. See FIG. 13, simulation results show that combining the best 26-RU to RU>26 to form an MRU yields negligible SNR gain where combining the best 26-RU to a given 26-RU gives >3 dB SNR.

Hence, for a 20 MHz frequency segment, in an example, a preferred MRU includes a combination of a middle 26-RU and its adjacent 52-RU/106-RU, or a combination of 2 26-RUs that are different from the already defined 52-RU. It may also called an aggregated middle 26-RU and its contiguous 52-RU or 106-RU, or an aggregated non-contiguous 26-RUs.

But even with the above restrictions, there are still too many entries required to support other MRU combinations so expanding the RU Allocation table may be impractical in some situation.

TABLE 3

| | | Additional | |
|---|---|---|---|
| | | entries | |
| | | required | |
| | | in RA | |
| | | subfield of | |
| # | Combination | 802.11 be | Remark |
| 1 | Single MRU: | 48 | There are 10 entries for |
| | Inner 52-RU + | | each 52-RU + middle26-RU |
| | middle 26-RU | | in RA subfield |
| 2 | Single MRU: | 96 | Including MU-MIMO |
| | 106-RU + | | |
| | middle 26-RU | | |
| 3 | Single MRU: 2 × 26 | 384 | Including MU-MIMO when |
| | | | allocation contains RU-106 |
| | | | Too many entries, may |
| | | | consider cancelling |
| | | | MU-MIMO for 106-RU |
| 4 | Single MRU: 2 × 26 | 214 | |
| | (w/o MUMIMO) | | |
| 5 | Two MRUs: | Hundreds | Too many entries requires |
| | 2 × 26 + 2 × 26 | | too much overhead, |
| 6 | Other combinations | Tens of | therefore makes this |
| | of MRU | thousands | impractical |

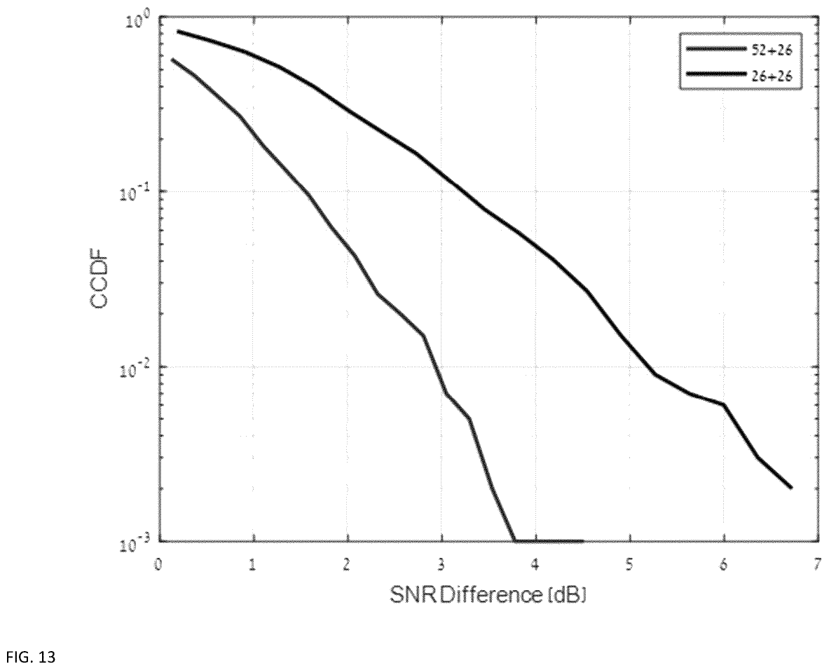

See the table 3, there are too many entries required to support other MRU combinations for example: 2 concurrent MRUs of 2×26-RU. Therefore, instead of expanding the RU Allocation subfield to a huge dimension, in an alternative embodiment 3, a new field is included for indicating the size and location of each RU aggregated in a MRU, which may be called Common-MRU. Examples are illustrated in FIG. 14.

This Common-MRU field exists only in case any MRU exists in the PPDU (in any of the 20 MHz channels). Therefore, the Common-MRU-field may be signaled either in a U-SIG previous to the EHT-SIG, or as an additional bit(s)/fields in the common field of the EHT-SIG.

For Small MRUs:
This Common-MRU field is encoded separately.
This Common-MRU field comprises 3 bitmap subfields, as following:
MRU_1—may be 9 bits, indicates which 26-RUs are comprised in a 1st MRU.
MRU_2—may be 7 bits, indicates which 26-RUs are comprised in a 2nd MRU.
MRU_3—may be 5 bits, indicates which 26-RUs are comprised in a 3rd MRU.

So, additional 21 (22 bits including the signaling bit which indicates whether a MRU is present/exists) are required for signaling any combination of up to 3 MRUs per 20 MHz frequency segment.

The amount of additional bits will be saved later due to the reduction in number of user-fields in the user-specific field.

In this embodiment, although the common-NRU field may appear as high overhead, we should bear in mind that a larger amount of additional bits will be saved later due to the reduction in the number of user-fields in the user-specific field.

For Large MRUs:
Large MRUs are identified by the corresponding RU Allocation subfield for RU>=242 tones.
In this case the Common-MRU field (bitmap) indicates which other RUs (>242) correspond to a same MRU.
MRU_1—may be 8 bits (9th bit is omitted): indicate which 242-RU belong to the MRU
MRU_2—omitted
MRU_3—omitted

Similar to the small MRU case, the user-specific field overhead is also reduced. That is, for a MRU indicated, one or more user field are included, no ID of station is repeated in different user field. Numbers stations or user fields indicated by the RU allocation field(s) still works when the station determine which RU/MRU is allocated to the station.

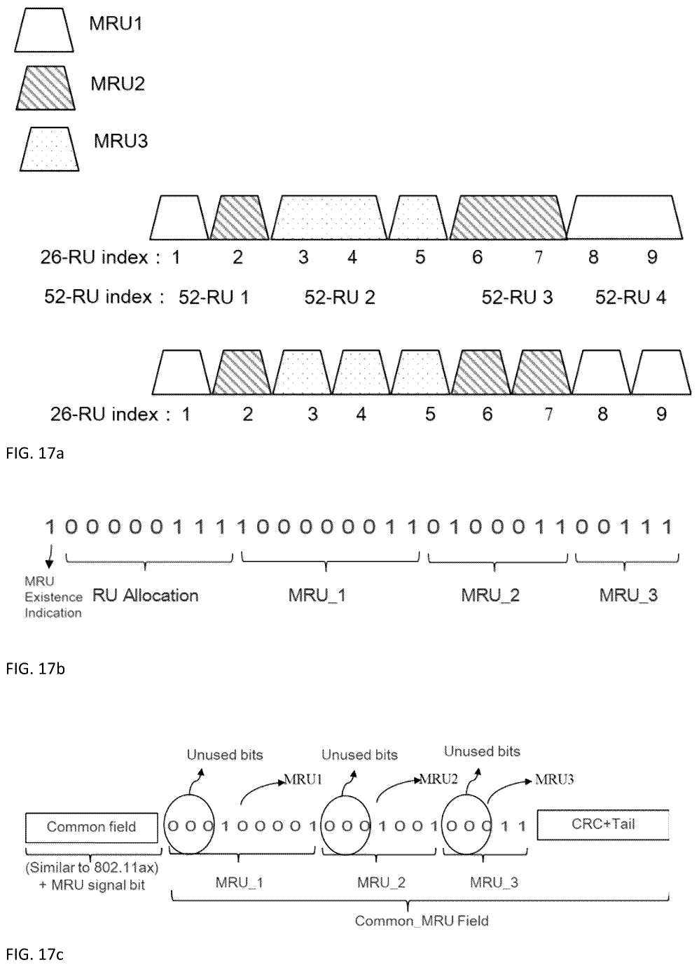

The user-specific field are included in the EHT-SIG, each RU/MRU indicated by the RU Allocation subfield and/or Common-MRU field is mapping to one or more user fields, usually the user fields are mapped to the MRU/RU in sequence. Since the location of the RUs in the MRU may be alternating, there should be some rules for the mapping the MRU and the one or more user-fields assigned to the MRU. In an example, the MRU's location is specified by the location of the first RU in lowest frequency domain. See the FIG. 17a, base on the frequency order of the 26-RU1, 26-RU 2 and the 52-RU 2, the MRU1 is the one in which the 26-RU1 is the lowest RU, the MRU 2 is the one in which the 26-RU 2 is the lowest RU, the MRU3 is the one in which the 52-RU 2 is the lowest RU.

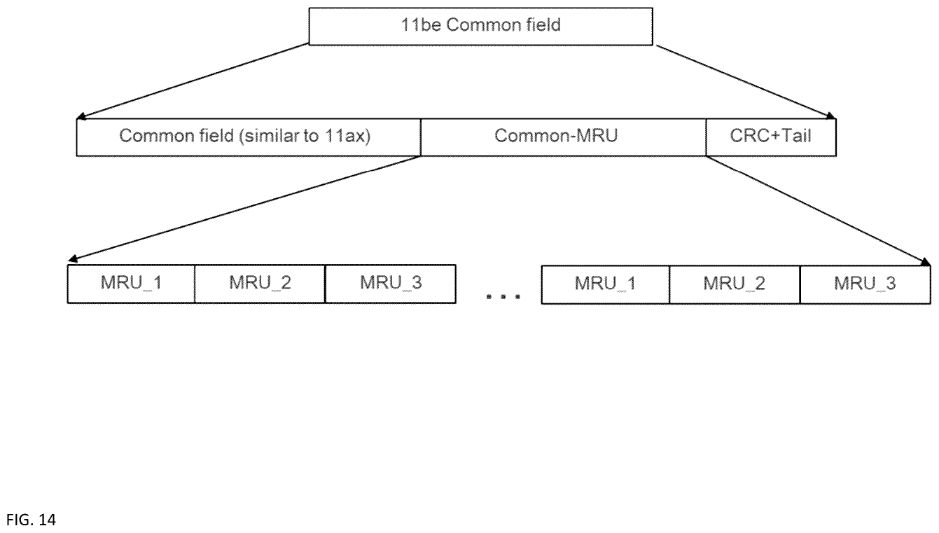

The one or more user-fields of a MRU/RU can be mapped to the MRU/RU in similar way in 802.11ax. A user-field location of a MRU will be in accordance with the RU of the lowest frequency as shown in the 2 examples in FIG. 15 and 1010. In another understanding, each user-field of a MRU points to the first RU (the RU located in the lowest frequency) of the MRU.

For MRU larger than 242-RU (or 106RU), MU-MIMO is supported, number of the user field corresponding to the MRU is also indicated. When the content is divided to CC1 and CC2, the number of the user field corresponding to the MRU in the CC1 and CC2 are respectively indicated.

In this solution, a STA can decode the user-specific field similarly to the way it does on 802.11ax. When decoding the user-specific field, STAs use the RU/MRU allocation or structure (signaled in the common field) to obtain the user fields on the RU/MRU. When necessary, skips the rest of the RUs of the same MRU.

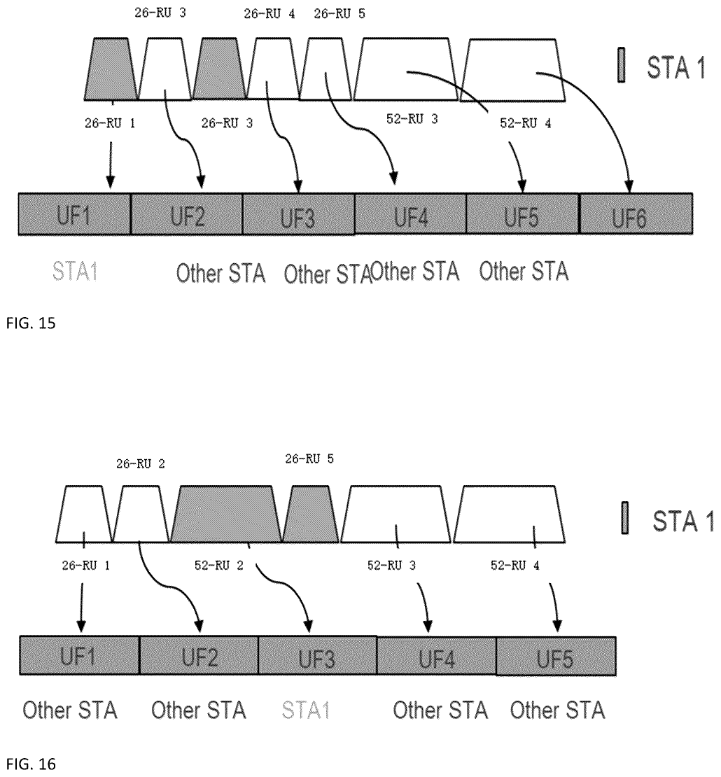

For example of the FIG. 15, MRU1 comprises the 26-RU-1 and 26-RU 3, the location of sequence/order of the MRU/RU is [MRU1, 26-RU 2, 26-RU 4, 26-RU 5, 52-RU 3, 52-RU 4], the user fields are mapped to the MRU/RU in sequence. For example of the FIG. 16, MRU1 comprises the 52-RU 2 and 26-RU 5, the location of sequence/order of the MRU/RU is [26-RU1, 26-RU 2, MRU1, 52-RU 3, 52-RU 4], the user fields are mapped to the MRU/RU in sequence.

FIG. 17a illustrated an example of RU/MRU allocation, which comprising 3 M-RU in a 20 MHz frequency segment. The complete common field “1 0 0 0 0 0 1 1 1 1 0 0 0 0 0 0 1 1 0 1 0 0 0 1 1 0 0 1 1 1” comprises, see FIG. 17b, an MRU indication, a RU allocation subfield, a first MRU bitmap, a second MRU bitmap, a third MRU bitmap. Details are in the following:

The MRU indication, which is 1 bit, indicating whether any MRU exists in the allocation;

The RU allocation subfield, which may be 8, 9 or 10 bits, indicating the sequence of the RUs (size and location of each RU) corresponding to the 20 MHz frequency segment. In the example, the “00000111” indicates the allocation of [26, 26, 52, middle-26, 52, 52].

The first MRU bitmap, marked as MRU_1, indicating which 26-RU is in the first mru. In the example, the 100000011 indicates the first, 8th and 9th 26-RUs are combined as the first MRU. The first MRU bitmap usually started with 1 (MSB is 1), which indicated the MRU comprising the 26-RU on the left edge.

The second MRU bitmap, marked as MRU_2, indicating which 26-RU is in the second MRU. In the example, the 0100011 indicates the second, 6th and 7th 26-RUs are combined as the second MRU. Only 6 bits required, therefore MSB is 0.

The third MRU bitmap, marked as MRU_3, indicating which 26-RU is in the third MRU. In the example, the 00111 indicates the second, 6th and 7th 26-RUs are combined as the second MRU. Only 3 bits are required, therefore 2 MSB are 0.

FIG. 17c, based on the same example of RU/MRU allocation, an alternative solution is provided in the following: The RU_allocation field in the common field of an EHT-SIG: indicating the size and location of RU(s) for a frequency segment, and the common field of an EHT-SIG further comprises one or more common-MRU fields, each common-MRU field indicating a RU indicated by the RU allocation field (i.e. an allocated RU) is in a MRU. This is different with the FIG. 17b that a granularity is used for the indication of MRU. It is preferred that the length of the common-MRU fields is decreasing in order, the order of the common-MRU fields is based on the first RU in the MRU in frequency domain.

For example, the RU_allocation field is set as 0 0 0 0 0 1 1 1.

The common-MRU field: Using a bitmap that is corresponding to the actual number of RUs, each bit indicating whether an RU indicated by the RU_allocation field is in a MRU. The unused bits are set to ‘0’.

The bits needed in this solution may be much shorter than the FIG. 17b. See FIG. 17c, 6 bits for MRU_1, 4 bits for MRU_2 and 2 bits for MRU_3.

The RU_allocation field: 0 0 0 0 0 1 1 1

Common-MRU field 1, MRU_1, indicating which RU is in the 1st MRU. For example, 0 0 0 1 0 0 0 0 1. Only 6 bits 1 0 0 0 0 1 is required, therefore 3 MSB may be set to 0 or for other function, some times the first 3 bits can be omitted.

Common-MRU field 2, MRU_2: 0 0 0 1 0 0 1. Only 4 bits required, therefore 3 MSB may be set to 0, or for other function, or be omitted.

Common-MRU field 3, MRU_3: 0 0 0 1 1. Only 2 bits are required, therefore 3 MSB may be set to 0, or for other functions.

The order of the Common-MRU field is in according with the order of the first RU in the MRU in frequency domain. See the FIG. 17a.

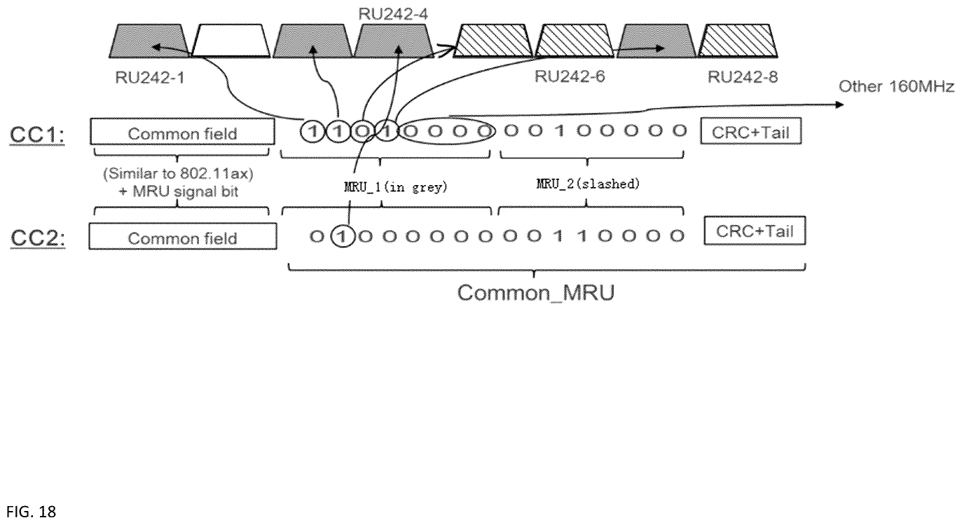

FIG. 18 provides a solution of indicating the RU/MRU allocation per 160 MHz BW for large MRU. In this example, there are 2 MRUs, one MRU comprises the 242-RU 1, 242-RU 3, 242-RU 4 and 242-RU 7 (show in grey). The other MRU comprises the 242-RU 5, 242-RU 6 and 242-RU8.

The EHT-SIG comprises CC1 and CC2. The information of EHT-SIG may be split into CC1 and CC2 to reduce overheads and increase robust of the information.

The common field of CC1 comprises: RU allocation information (field) per 20 MHz or per 40 MHz frequency segments, for odd numbered 20 MHz or 40 MHz frequency segments. For example in this example, 1 1 1 0 0 x x x for a 20 MHz frequency segments.

The common field of CC2 comprises: RU allocation information (field) per 20 MHz or per 40 MHz frequency segments, for even numbered 20 MHz or 40 MHz frequency segments. For example in this example, 1 1 1 0 0 x x x for a 20 MHz frequency segments.

In alternative solutions, the above common field may be omitted by other solutions, or be indicated in the way described in the other embodiments.

The MRU_1 is valid and is 8 bits of length.

The MRU_1 field in the CC1 is corresponding to the odd numbered 20 MHz or 40 MHz segments too. In the example of FIG. 18, the beginning four bits respectively maps to the 1st, 3d, 5th and 7th 20 MHz segments in the primary 160 MHz or the only 160 MHz BW. If the BW is 320 MHz, the following four bits respectively maps to the 9th, 11th, 13th and 15th 20 MHz segments.

The MRU_1 field in the CC2 is corresponding to the even numbered 20 MHz or 40 MHz segments too. In the example of FIG. 18, the beginning four bits respectively maps to the 1st, 3d, 5th and 7th 20 MHz segments in the primary 160 MHz or the only 160 MHz BW. if the BW is 320 MHz, the following four bits respectively maps to the 9st, 11d, 13th and 15th 20 MHz segments.

Similarly, the MRU_2 field indicates the RUs in the MRU2 by the similar method of MRU_1 field.

In some solutions, MRU_2 and MRU_3 are omitted based on the MRU signal bit and the RA subfield in the common part.

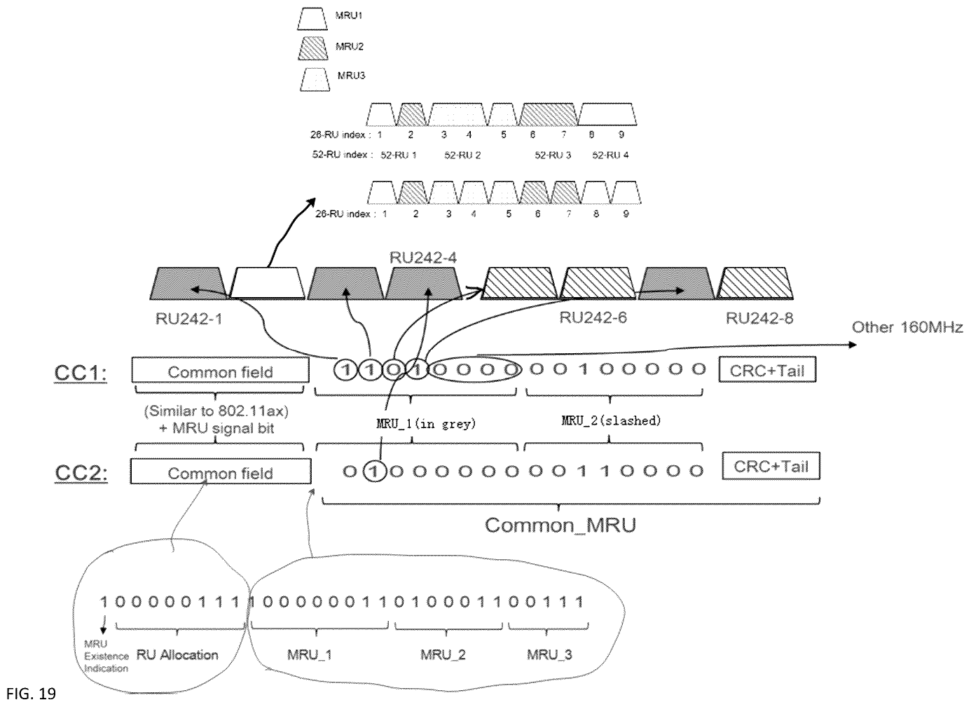

FIG. 19 provides an example of a transmission contains a mixed type of MRU (large MRU and small MRU). In this example, the 242-RU 2 is allocated as the small MRUs such as the FIGS. 17a and 14b, other 242-RUs are allocated in the large MRU, such as FIG. 18.

RA fields (including the RA 2 for the 242-RU 2) are located in the common part of EHT-SIG in similar way of FIG. 18.

The small MRU_1/2/3 field may be added at location of MRU field corresponding to RA2 in CC2.

In this embodiment, by providing a Common sub-field with MRU bitmap, many technical advantages are obtained: any combination of MRU may be defined, can avoid expanding the RU Allocation subfield, make the implementation practical, and further overall overhead in EHT-SIG is reduced.

### Embodiment 4

In this embodiment, MRUs are allowed to be allocated to one station and preamble puncturing is also considered. This embodiment works in the case that allocation of a large RU (RU>484), such as a 996-RU or a 1992-RU(2*996-RU) or a 3984-RU(2*996-RU) where some of the 20 MHz portions included in them are punctured. In this case, the information already available about the channel puncturing is used to define a large punctured RU as a single RU instead of several smaller RUs. This information may be available in a field preceding to EHT-SIG which may be called “U-SIG”, may be indicated by 2 or more bits. The common part of EHT-SIG does not include information about puncturing of sub-channels (20 MHz).

Assuming puncturing is usually occur (especially in dense networks). Referring to RU>484, the puncturing information is included in a SIG (likely to be defined in U-SIG), the puncturing information is used for defining or indicating a non-contiguous large RU (punctured RU), accordingly a SIG may further includes a single user-specific field (in EHT-SIG), in which one or more user fields are included corresponding to the non-contiguous large RU. One or more user fields include different station's information respective. Those stations are thus assigned to the non-contiguous large RU by MU-MIMO.

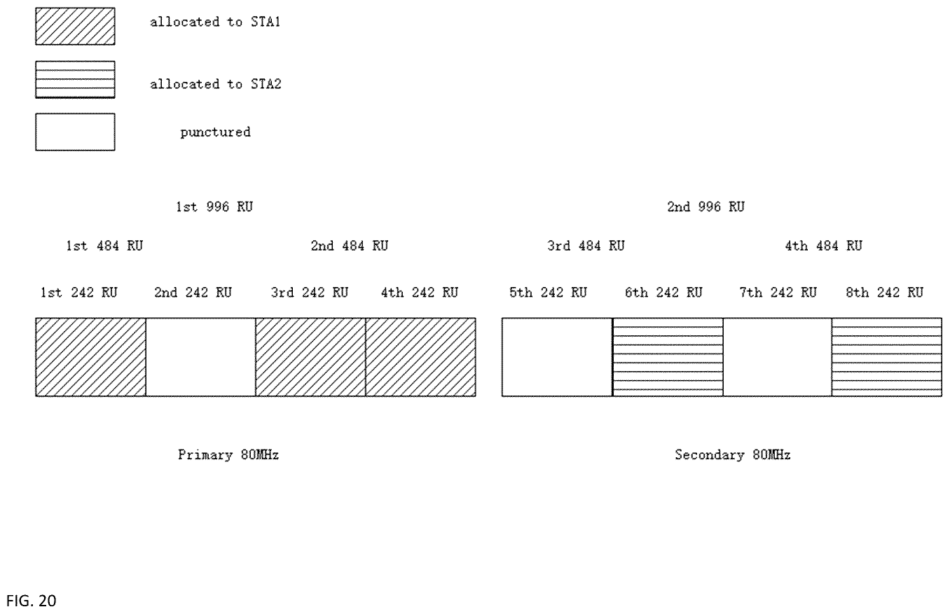

FIG. 20 shows an example of the above embodiment in a bandwidth of 160 MHz. In the example, a first 996-RU is allocated to STA1, in which the 2nd 242-RU is punctured, this allocations equals that the 1st 242-RU and the 2nd 484-RU are allocated to STA1. A second 996-RU is allocated to STA2, in which the 2nd 242-RU is punctured The 6th 242-RU and 8th 242-RU are allocated to the STA2. In the example, the frequency resource allocated to STA1 can be defined or considered as one punctured 996-RU (shown as the primary 80 MHz). A single user specific field (in which different user field with different stations' information) can be included corresponding to the punctured 996-RU in an EHT-SIG, instead of the embodiment 1, i.e. two RUs that require two user fields, in which a first user field corresponds to the 1st 242-RU, a second user field corresponds to the 2nd 484-RU, the first user field and second user field comprises same ID of stations. Similarly, the frequency resource allocated to STA2 can also be defined or considered as one punctured 996-RU (shown as the secondary 80 MHz). A single RU can be included corresponding to the punctured 996-RU in the EHT-SIG, instead of the embodiment 1, i.e. two RUs that require two user fields, in which a first user field corresponds to the 6th 242-RU, a second user field corresponds to the 8nd 242-RU.

When a STA realizes that RU-996 is assigned to it, it already knows that this RU is punctured.

### Reduce Overhead

Moreover, any receiver that supports the suggested method (specifically Huawei's device) may easily decode the signals that are defined by the same suggested method, thus disclosing the use of the invention by a competitor transmitter.

### Embodiment 5

As mentioned in embodiment 3, a new table may be defined, in which the newly defined MRU are also indicated by defined index/bit sequences of in the RU Allocation subfield.

The RU Allocation subfield (RA) may be 8 bits, 9 bits, 10 bits or more bits, corresponding to a 20 MHz segment. The more the bits are in the RA, the more MRUs can be supported, that is, one or more of the above listed MRU may be in an RU allocation and indicated by the index corresponding to the RU allocation. When more stations can be assigned to a RU or MRU more bits are needed to indicate the number of the stations. When the MRU in the RU allocation and number of stations on the MRU has been indicated, the mapping between the RU/MRU and the user fields are indicated by the sequence of the RU/MRU and the sequence of the stations/user fields, that is, one to one mapping in order.

As mentioned that the RUs assignment is decided by the AP according to various criterion. Needed resources of a station in a transmission is considered when determine the preferred RU or MRU.

To reduce the complexity of the table, preferred or limit allocation of RU or MRU are defined in the table, un-efficient allocation of RU/MRU are not allowed.

The following table 4 is an example of the needed resources (especially smaller than a 20 MHz) and the preferred RU or MRU based on the needed resources.

TABLE 4

| Resources needed | |
|---|---|
| at most(number | |
| of subcarriers) | |
| by a station | preferred RU/MRUs/full bandwidth |
| 1 × 26 | 26-RU |
| 2 × 26 | 52-RU |
| 3 × 26 | adjacent 52 + middle 26 MRU |
| 4 × 26 | 106-RU |
| 5 × 26 | 106 + middle 26 MRU |
| 6 × 26 | 106 + 52 MRU |
| 7 × 26 | 106 + 52 + middle 26 MRU |
| 8 × 26 | 106 + 106 MRU |
| 9 × 26 | 242-RU; full bandwidth in a 20 MHz |
| | PPDU |

A new indexes table of RU Allocation subfield may need to consider the above preferred RU/MRUs, and number of the MRU, locations of each RU in the MRU may also being considered. The more flexible the MRU is the more indexes are needed.

The following table 5 is another example of the needed resources (especially larger than a 20 MHz, 320 MHz bandwidth is supported), and the preferred RU or MRU based on the needed resources which need an entry in the indexes table of RU Allocation subfield.

TABLE 5

| Resources needed | |
|---|---|
| at most(number | |
| of subcarriers) | |
| by a station | preferred RU/MRUs |
| 1 × 242 | 242-RU; full bandwidth in a 20 MHz |
| | PPDU |
| 2 × 242 | 484-RU; full bandwidth in a 40 MHz |
| | PPDU |
| 3 × 242 | At largest contiguous 3 242-RU (a MRU |
| | started by a start 242-RU which the first |
| | RA indicating the 3 × 242 correspond |
| | to, may be punctured by a second RA |
| | corresponding to a 20 MHz following |
| | the start 242-RU in frequency) |
| 4 × 242 | At largest contiguous 4 242-RU(996-RU); |
| | full bandwidth in a 80 MHz PPDU; |
| 5 × 242 | At largest contiguous 5 242-RU |
| 6 × 242 | At largest contiguous 6 242-RU, |
| | may be punctured |
| 7 × 242 | At largest contiguous 7 242-RU |
| 8 × 242 | At largest contiguous 8 242-RU |
| 9 × 242 | At largest contiguous 9 242-RU |
| 10 × 242 | At largest contiguous 10 242-RU |
| 11 × 242 | At largest contiguous 11 242-RU |
| 12 × 242 | At largest contiguous 12 242-RU |
| 13 × 242 | At largest contiguous 13 242-RU |
| 14 × 242 | At largest contiguous 14 242-RU |
| 15 × 242 | At largest contiguous 15 242-RU |
| 16 × 242 | full bandwidth in a 320 MHz PPDU |

The at largest contiguous M 242-RU (a large MRU) in the above is defined and mapped to an index, the large MRU starts in frequency domain from a start 242-RU which a beginning RA indicating the M×242 corresponds (the very first RA in the common part of EHT-SIG indicating the M×242 MRU), this large MRU may be punctured by a second RA corresponding to a 20 MHz following the start 242-RU in frequency domain).

The large MRU may be further limited in the following Table 6, which need an entry in the indexes table of RU Allocation subfield:

TABLE 6

| Resources needed | |
|---|---|
| at most(number | |
| of subcarriers) | |
| by a station | preferred RU/MRUs |
| 1 × 242 | 242-RU; full bandwidth in a 20 MHz |
| | PPDU |
| 2 × 242 | 484-RU; full bandwidth in a 40 MHz |
| | PPDU |
| 3 × 242 | At largest contiguous 3 242-RU (a |
| | MRU started by a start 242-RU which the |
| | first RA indicating the 3 × 242 correspond |
| | to, may be punctured by a second RA |
| | corresponding to a 20 MHz following the |
| | start 242-RU in frequency) |
| 4 × 242 | At largest contiguous 4 242-RU(996- |
| | RU); full bandwidth in a 80 MHz PPDU; |
| 5 × 242 | At largest contiguous 5 242-RU |
| 6 × 242 | At largest contiguous 6 242-RU, may |
| | be puctured |
| 7 × 242 | At largest contiguous 7 242-RU |
| 8 × 242 | At largest contiguous 8 242-RU |

The large MRUs may be further reduced.

The entries needed for each of the large MRU may be based on the numbers of the stations can be assigned on the large MRU. For example, when 16 stations of MU-MIMO are supported, entry of each large MRU may be 16. The values of the indexes are not limited, 2, 3 or 4 bits in the index is used to indicate the number of stations on the large MRU.

Based on the above solution, the examples in the FIG. 6, in the 160 MHz, the first, third, 4th, 5th 242-RU are assigned to STA1; the 6th, 8th 242-RU are assigned to STA2. The RU allocation may be indicated by the common part of EHT-SIG in the following:

the common part of CC1 comprises “RA-1, indicating 5×242 MRU(n1)); RA-3, indicating 5×242 MRU(n1); RA-5, indicating 5×242 MRU(n1); RA-7, indicating 242(n4)”;

the common part of CC2 comprises “RA-2, indicating 242(n2); RA-4, indicating 5×242 MRU(n1); RA-6, indicating 3×242 MRU(n3), RA-8, indicating 3×242 MRU(n3)”.

The n1, n2, n3, n4 is the number of the stations on the large MRU in CC1 or CC2.

In the above mentioned embodiment, only common part of the EHT-SIG is discussed, the user specific field may be similar to the solution of the 802.11ax. A sequence of user fields are positioned in the user specific field of a corresponding EHT-SIG, mapping with the RU or MRU in the allocation indicated by the RA field.

In some special situation, besides the MRU indicated by the RA field, other kind of MRU can be indicated by the user fields.

### Embodiment 6

Embodiments can be combined in a way where it can work and being amended in a way still works or work better, the following are some examples. In the embodiment 6a signaling method for small RUs is provided where the indication field in the common part of EHT-SIG consists of two fields, the existing RA field and additional signaling of MRU allocation.

This method allows to define any combination of small RUs as MRU while preserving the definition of 20 MHz allocation map of 802.11ax (the RU Allocation subfield).

The indication consists of RA field and additional signaling indicating which RUs that are defined in RA field are allocated as MRU.

For example, if we want to allocate the following map {26, 26+52, center 26, 26, 26, 52};

where second 26-RU and second 52-RU comprise a MRU, we first indicate a RA field of 8 bits ‘00000101’ which defines the allocation map of

{26, 26, 52, center 26, 26, 26, 52};

and then indicate specifically MRU comprised of the second 26-RU and the second 52-RU.

In this method single user-specific field will be indicated in EHT-SIG per MRU, see single user-specific field specified in the embodiment.

### Embodiment 6a

In this embodiment, method is provided for indicating MRU allocation using a bitmap where each bit corresponds to specific RU which is defined in RA field.

Every 20 MHz may include up to 4 MRUs thus MRU allocation field will comprise of 4 parts. In alternative solutions, may be 1, 2 or 3 MRU are allowed.

The 1st Part—First MRU may be any combination of RUs defined in RA field.

Maximum number of RUs in 20 MHz is 9 thus in order to cover all the possible allocations we use 9 bits. The actual number of bits used for MRU allocation will be equal to a number of RUs defined in RA field starting from LSB or MSB of 9 bits. If the number of RUs defined in RA field is less than 9, the redundant bits are don't-care bits.

For example, RA field ‘00000101’ defines a RU allocation of

[26, 26, 52, center 26, 26, 26, 52];

And a bitmap of 0 0 1 1 0 0 0 means that second 52-RU and center 26-RU are allocated as MRU while two don't-care bits will be added to the bitmap.

The 2nd Part—Second MRU may be any combination of those RUs defined in RA field and not included in the first MRU.

Maximum number of RUs excluding first MRU is 7 thus we use a bitmap of 7 bits. The actual number of bits used for second MRU will be equal to number of RUs defined in RA field minus number of RUs comprising first MRU starting from LSB or MSB of 7 bits, the redundant bits are don't-care bits.

For example, following the allocation defined in previous section a bitmap of 1 1 0 0 0 means that first and second 26-RU are allocated as MRU while two don't-care bits will be added to the bitmap.

The 3rd Part—Third MRU may be any combination of those RUs defined in RA field and not included in first and second MRU.

Maximum number of RUs excluding first and second MRU is 5 thus we use a bitmap of 5 bits. The actual number of bits used for second MRU will be equal to number of RUs defined in RA field minus number of RUs comprising first and second MRU starting from LSB or MSB of 5 bits, the redundant bits are don't-care bits.

For example, following the allocation defined in previous two sections a bitmap of 0 1 1 means that 7th 26-RU and 4th 52-RU are allocated as MRU

The 4th Part—Fourth MRU may be any combination of those RUs defined in RA field and not included in first, second and third MRU.

Maximum number of RUs excluding first, second and third MRU is 3 thus we use a bitmap of 3 bits.

In this example, the common field of EHT-SIG comprises: one or more RA fields, each RA field is of 8 bits and one or more MRU allocation fields, which may be 9, 7, 5, 3 bits respectively.

In some alternative solutions, if limit modes of MRU are defined, this embodiment can also be revised accordingly, such as only includes bits for the RU which is allowed to be aggregated to MRU. Such as when only 26RU-3, 26RU-4, 26RU-5, 26RU-6, 26RU-7 are allowed to be aggregated to a MRU, a first MRU allocation field and a second MRU allocation field may occupy 5 bits, 3 bits respectively.

### Embodiment 6b

In this embodiment a similar method as in embodiment 6a is provided, while all the bits of the bitmap of each part defined in embodiment 6a are used to indicate an allocated MRU with no don't-care bits. Each bit in the bitmap corresponds a specific 26-RU, while RUs larger than 26 will be indicated by consecutive bits in the bitmap. For example in order to allocate first 52-RU and last 52-RU as first MRU we will define a bitmap of ‘1 1 0 0 0 0 0 1 1’ where the first two 1s correspond 1st 52-RU and last two 1s correspond the last 52-RU.

In this method the common field of EHT-SIG consists of 8 bits of RA field and 9+7+5+3 bits of MRU allocation field.

### Embodiment 6c

In this embodiment a method similar to embodiment 6a and 6b while the number of MRUs is indicated in EHT-SIG by a N_MRU field. If a N_MRU field is set to zero it means no MRU is allocated and a common field of EHT-SIG will include no bitmap. If a N_MRU field is set to a number between 1/2/3/4, then 1/2/3/4 MRUs are allocated and a corresponding number of bitmaps will be included as defined in embodiments 6a and 6b.

In this method the common field of EHT-SIG consists of: one or more RA field (8 bits) and zero or 9 or 9+7 or 9+7+5 or 9+7+5+3 bits of a MRU allocation field according to the number of MRUs indicated by N_MRU bits.

### Embodiment 6d

In this embodiment an additional resource allocation table is defined, that includes all the defined combinations of MRUs. It may be a MRA field—Multiple Resource Allocation field. Each entry of MRA defines a map that may comprise a single MRU or a combination of MRUs. The map defines only MRUs while a complete allocation map of 20 MHz is defined by a RA field.

For example, if the following map of 20 MHz is to be allocated

[26, 26, 52+center 26, 26, 26, 52];

then RA field of ‘00000101’ will indicate the map of [26, 26, 52, center 26, 26, 26, 52];

and a new MRA entry may be defined where second 52-RU and center 26-RU are allocated as single MRU.

The new MRA field will not indicate any single RU, only MRUs thus any RA field entry where 2nd 52-RU and center 26-RU are allocated may be combined with MRA field where those RUs are allocated as MRU.

In this method the common part of EHT-SIG comprises one or more RA fields (each RA field is 8 bits) and additional Nbits of MRA field.

The number of Nbits defines a size of MRA table with 2\hat{ }Nbits options of MRUs map.

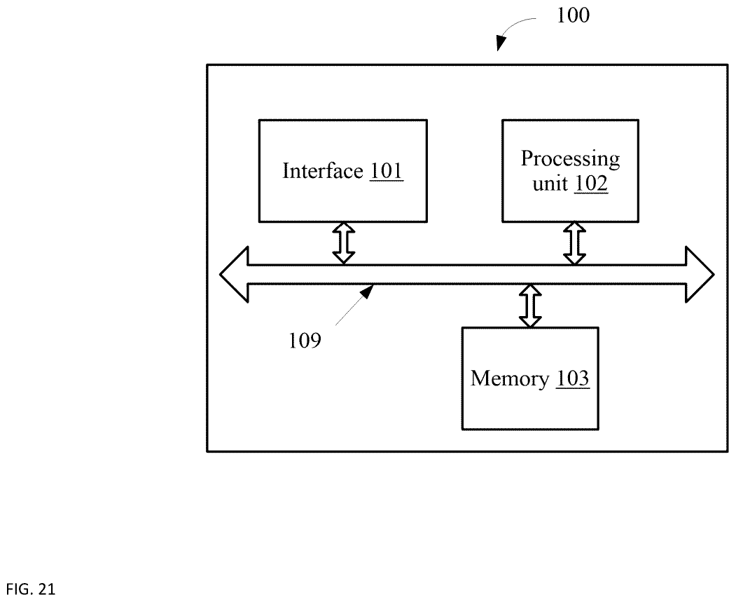

FIG. 21 is a block diagram of an access point according to another embodiment of the present invention. The access point in FIG. 21 comprises an interface 101, a processing unit 102, and a memory 103. The processing unit 102 controls an operation of the access point 100. The memory 103 may include a read-only memory and a random access memory, and provides an instruction and data for the processing unit 102. A part of the memory 103 may further include a nonvolatile random access memory (NVRAM). All components of the access point 100 are coupled together by using a bus system 109, and in addition to a data bus, the bus system 109 further comprises a power bus, a control bus, and a status signal bus. However, for clarity of description, various buses are marked as the bus system 109 in FIG. 21.

The methods for sending the foregoing various frames disclosed in the foregoing embodiments of the present invention may be applied to the processing unit 102, or implemented by the processing unit 102. In an implementation process, each step of the foregoing methods may be completed by means of an integrated logic circuit of hardware in the processing unit 102 or an instruction in a software form. The processing unit 102 may be a general purpose processor, a digital signal processor, an application-specific integrated circuit, a field programmable gate array or another programmable logic device, a discrete gate or a transistor logic device, or a discrete hardware component, and may implement or execute various methods, steps, and logic block diagrams disclosed in the embodiments of the present invention. The general purpose processor may be a microprocessor, any conventional processor, or the like. The steps of the method disclosed with reference to the embodiments of the present invention may be directly performed by a hardware processor, or may be performed by using a combination of hardware in the processor and a software module. The software module may be located in a mature storage medium in the field, such as a random access memory, a flash memory, a read-only memory, a programmable read-only memory, an electrically-erasable programmable memory, or a register. The storage medium is located in the memory 103. The processing unit 102 reads information in the memory 103, and completes the steps of the foregoing methods with reference to the hardware of the processing unit 102.

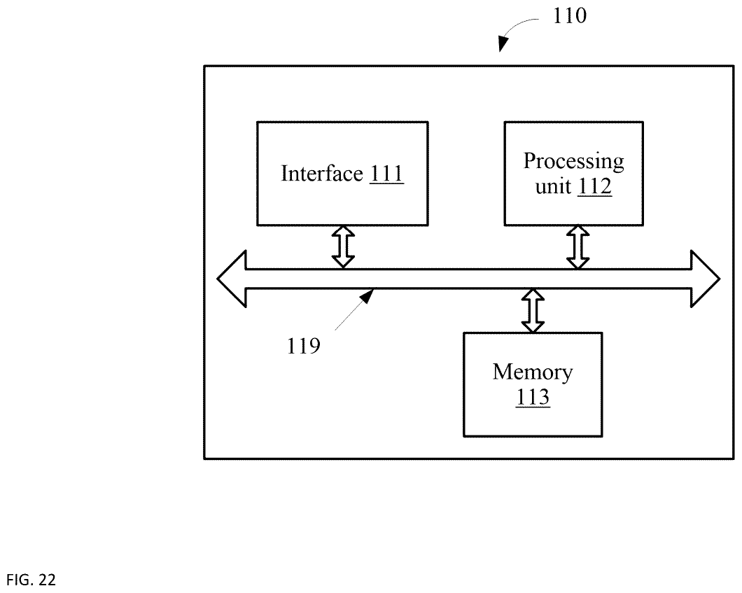

FIG. 22 is a block diagram of a station according to another embodiment of the present invention. The station comprises an interface 111, a processing unit 112, and a memory 113. The processing unit 112 controls an operation of the station 110. The memory 113 may include a read-only memory and a random access memory, and provides an instruction and data for the processing unit 112. A part of the memory 113 may further include a nonvolatile random access memory (NVRAM). All components of the station 110 are coupled together by using a bus system 119, and in addition to a data bus, the bus system 119 further comprises a power bus, a control bus, and a status signal bus. However, for clarity of description, various buses are marked as the bus system 119 in FIG. 22.

The methods for receiving the foregoing various frames disclosed in the foregoing embodiments of the present invention may be applied to the processing unit 112, or implemented by the processing unit 112. In an implementation process, each step of the foregoing methods may be completed by means of an integrated logic circuit of hardware in the processing unit 112 or an instruction in a software form. The processing unit 112 may be a general purpose processor, a digital signal processor, an application-specific integrated circuit, a field programmable gate array or another programmable logic device, a discrete gate or a transistor logic device, or a discrete hardware component, and may implement or execute various methods, steps, and logic block diagrams disclosed in this embodiment of the present invention. The general purpose processor may be a microprocessor, any conventional processor, or the like. The steps of the method disclosed with reference to the embodiments of the present invention may be directly performed by a hardware processor, or may be performed by using a combination of hardware in the processor and a software module. The software module may be located in a mature storage medium in the field, such as a random access memory, a flash memory, a read-only memory, a programmable read-only memory, an electrically-erasable programmable memory, or a register. The storage medium is located in the memory 113. The processing unit 112 reads information in the memory 113, and completes the steps of the foregoing methods with reference to the hardware of the processing unit 112.

Specifically, the memory 113 stores received information that enables the processing unit 112 to execute the methods mentioned in the foregoing embodiments.

The detailed description set forth above in connection with the appended drawings describes examples and does not represent the only examples that may be implemented or that are within the scope of the claims. The terms example” and “exemplary, when used in this description, mean “serving as an example, instance, or illustration,” and not “preferred’ or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by Voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in Software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed Such that portions of functions are implemented at different physical locations. As used herein, including in the claims, the term “and/or, when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, ‘or’ as used in a list of items (for example, a list of items prefaced by a phrase such as “at least one of or “one or more of) indicates a disjunctive list such that, for example, a list of “at least one of A, B, or C’ means A or B or C or AB or AC or BC or ABC (i.e., A and B and C).

Computer-readable media includes both computer storage media and communication media including any medium that facilitates transfer of a computer program from one place to another. A storage medium may be any avail able medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic Storage devices, or any other medium that can be used to carry or store desired program code means in the form of instructions or data structures and that can be accessed by a general-purpose or special-purpose computer, or a general purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies Such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the Scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

It should be understood that “an embodiment” or “an embodiment” mentioned in the whole specification does not mean that particular features, structures, or characteristics related to the embodiment are included in at least one embodiment of the present invention. Therefore, “in an embodiment” or “in an embodiment” appearing throughout the specification does not refer to a same embodiment. In addition, these particular features, structures, or characteristics may be combined in one or more embodiments by using any appropriate manner. Sequence numbers of the foregoing processes do not mean execution sequences in various embodiments of the present invention. The execution sequences of the processes should be determined according to functions and internal logic of the processes, and should not be construed as any limitation on the implementation processes of the embodiments of the present invention.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is only an example. For example, the unit division is only logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present invention.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

What is claimed is:

1. An apparatus for wireless communication, comprising:
a memory that stores instructions; and
a processor coupled with the memory, wherein the processor is configured to execute the instructions in the memory to cause the processor to:
receive a signaling field (SIG), wherein the SIG includes a resource unit (RU) allocation field indicating a size and location of an RU or MRU in a frequency resource, and one or more user fields, each of the one or more user fields includes a station identifier (STA ID) of a scheduled station (STA);
wherein the MRU which includes multiple RUs is assigned to one or more STAs, and the RU allocation field indicates size and location of each RU comprised in the MRU;
wherein the one or more user fields comprise a single RU user field and an MRU user field; the single RU user field corresponds to an RU which is not an MRU; the MRU user field corresponds to an MRU;
process the SIG.

2. The apparatus according to claim 1, wherein the MRU is a small MRU, which includes combination of 26-RU, 52-RU, or 106-RU in a 20 MHz frequency segment; or the MRU is a large MRU which includes combination of 242-RU, 484-RU, or 996-RU in a transmission bandwidth.

3. The apparatus according to claim 1, wherein a common field of the SIG includes at least one of information for small MRU allocated in a corresponding 20 MHz frequency segment, and information for a number of a large MRU allocated in a bandwidth of the transmission.

4. The apparatus according to claim 1, wherein the SIG includes a Common-MRU field indicating at least one of which 26-RUs are included in an MRU in a corresponding 20 MHz frequency segment, and which 242-RUs are included in an MRU in a bandwidth of the transmission.

5. The apparatus according to claim 1, wherein the SIG includes one or more Common-MRU fields, a Common-MRU field indicating which actual allocated RUs are in an MRU.

6. The apparatus according to claim 1, wherein the SIG includes puncturing information, indicating a non-contiguous large RU and one or more user-fields corresponding to the non-contiguous large RU, the one or more user-fields include a different station's information.

7. A method for wireless communication, comprising:
receiving a signaling field (SIG), wherein the SIG includes a resource unit (RU) allocation field indicating a size and location of an RU or MRU in a frequency resource, and one or more user fields, each of the one or more user fields includes a station identifier (STA ID) of a scheduled station (STA);
wherein the MRU which includes multiple RUs is assigned to one or more STAs, and the RU allocation field indicates size and location of each RU comprised in the MRU;
wherein the one or more user fields comprise a single RU user field and an MRU user field; the single RU user field corresponds to an RU which is not an MRU; the MRU user field corresponds to an MRU;
processing the SIG.

8. The method according to claim 7, wherein the MRU is a small MRU which includes combination of 26-RU, 52-RU, or 106-RU in a 20 MHz frequency segment, and the MRU is a large MRU which includes combination of 242-RU, 484-RU, or 996-RU in a transmission bandwidth.

9. The method according to claim 7, wherein a common field of the SIG includes at least one of information for small MRU allocated in a corresponding 20 MHz frequency segment, and information for a number of the large MRU allocated in a bandwidth of the transmission.

10. The method according to claim 7, the SIG includes a Common-MRU field indicating which 26-RUs are included in an MRU in a corresponding 20 MHz frequency segment, and indicating which 242-RUs are included in an MRU in a bandwidth of the transmission.

11. The method according to claim 7, the SIG includes one or more Common-MRU fields, a Common-MRU field indicating which actual allocated RUs are in an MRU.

12. The method according to claim 7, the SIG includes puncturing information, indicating a non-contiguous large RU and one or more user-fields corresponding to the non-contiguous large RU, the one or more user-fields including a different station's information.

13. A non-transitory computer readable medium configured to store instructions thereon, wherein the instructions, when executed by a processor, cause the processor to:
receive a signaling field (SIG), wherein the SIG includes a resource unit (RU) allocation field indicating a size and location of an RU or MRU in a frequency resource, and one or more user fields, each of the one or more user fields includes a station identifier (STA ID) of a scheduled station (STA);
wherein the MRU which includes multiple RUs is assigned to one or more STAs, and the RU allocation field indicates size and location of each RU comprised in the MRU;
wherein the one or more user fields comprise a single RU user field and an MRU user field; the single RU user field corresponds to an RU which is not an MRU; the MRU user field corresponds to an MRU;
process the SIG.

14. The non-transitory computer readable medium according to claim 13, wherein the MRU is a small MRU, which includes combination of 26-RU, 52-RU, or 106-RU in a 20 MHz frequency segment; or the MRU is a large MRU which includes combination of 242-RU, 484-RU, or 996-RU in a transmission bandwidth.

15. The non-transitory computer readable medium according to claim 13, wherein a common field of the SIG includes at least one of information for small MRU allocated in a corresponding 20 MHz frequency segment, and information for a number of the large MRU allocated in a bandwidth of the transmission.

16. The non-transitory computer readable medium according to claim 13, the SIG includes a Common-MRU field indicating which 26-RUs are included in an MRU in a corresponding 20 MHz frequency segment, and indicating which 242-RUs are included in an MRU in a bandwidth of the transmission.

17. The non-transitory computer readable medium according to claim 13, the SIG includes one or more Common-MRU fields, a Common-MRU field indicating which actual allocated RUs are in an MRU.

18. The non-transitory computer readable medium according to claim 13, the SIG includes puncturing information, indicating a non-contiguous large RU and one or more user-fields corresponding to the non-contiguous large RU, the one or more user-fields including a different station's information.
